(19) United States
(12) Patent Application Publication
(10) Pub. No.: US 2007/0242880 A1
(43) Pub. Date: Oct. 18, 2007

(54) System and method for the identification of motional media of widely varying picture content

(76) Inventor: David W. Stebbings, Fairfax, VA (US)

Correspondence Address: WILMER CUTLER PICKERING HALE AND DORR LLP, 399 PARK AVENUE, NEW YORK, NY, 10022, US

(21) Appl. No.: 11/787,760

(22) Filed: Apr. 17, 2007

Related U.S. Application Data
(63) Continuation-in-part of application No. 11/728,948, filed on Mar. 27, 2007.
(63) Continuation-in-part of application No. 11/431,654, filed on May 11, 2006.
(60) Provisional application No. 60/792,749, filed on Apr. 18, 2006.
(60) Provisional application No. 60/786,812, filed on Mar. 28, 2006.
(60) Provisional application No. 60/682,011, filed on May 18, 2005.

(51) Int. Cl. G06K 9/00

(52) U.S. Cl. 382/172; 348/699; 382/165

(57) ABSTRACT

One or more embodiments of the present invention is directed to a system and method that identifies motional media content from the actual initially unknown program under review. Embodiments of the present invention identifies the content by searching a database to derive the relevant information about the owner, copyright holder and other pertinent facts such as copy and play permissions. It further provides methods for deriving the frame or picture count and time between shot or scene changes, the sequence of measurements or vectors having been already established from an original master or copy is provided. Embodiments of the present invention identifies pictures of widely varying brightness, rapid movement, or flicker that could cause errors in the detection of cuts, particularly for establishing the identity of a low quality sources. Methods, in accordance with one or more embodiments of the present invention, improve the operation of the system for these types of media. A system according to one or more embodiments of the present invention can be implemented with video or audio channels that do not include any information. A method according to one or more embodiment of the present invention is extremely robust against attempts at circumvention.

### RELATED APPLICATIONS

This application claims priority to U.S. provisional patent application No. 60/792,749, titled “SYSTEM AND METHOD FOR THE IDENTIFICATION OF MOTIONAL MEDIA OF WIDELY VARYING PICTURE CONTENT” filed on Apr. 18, 2006,

This application is a continuation-in-part application of co-pending U.S. patent application Ser. No. 11/728,948 titled “SYSTEM AND METHOD FOR THE IDENTIFICATION OF MOTIONAL MEDIA IN PLAYERS AND RECORDERS WITHOUT INTERNET ACCESS” filed on Mar. 27, 2007, which in turn claims priority to 60/786,812, titled “SYSTEM AND METHOD FOR THE IDENTIFICATION OF MOTIONAL MEDIA IN PLAYERS AND RECORDERS WITHOUT INTERNET ACCESS” filed on Mar. 28, 2006. This application is also a continuation-in-part application of co-pending U.S. patent application Ser. No. 11/431,654, titled “SYSTEM AND METHOD FOR THE IDENTIFICATION OF MOVIES, OR ANY MOTIONAL VISUAL CONTENT” filed May 11, 2006, and which claims priority to U.S. Provisional Patent Application No. 60/682,011, filed on May 18, 2005, all of which are incorporated herein by reference in its entirety for all purposes.

### BACKGROUND OF THE INVENTION

1. Field of the Invention

The present invention is directed to computer related and/or assisted system, method, computer readable medium and program for Intellectual Property Detection. More particularly, the present invention relates to systems and methods for identifying visual optical or electronic motional media files with fast and computationally simple mathematical algorithms. Derived identifiers can be used to search a database that contains identifiers of many files and thus assign the ownership and copyright holder to that particular content. The invention relates to improving the robustness of the system with rapidly and widely varying pictures in the program.

2. Background Description

In recent years Intellectual Property (IP) concerning video and audio content has become an important issue for at least two reasons. First, it is the product of an industry worth multi-billion dollars per annum and is one of the leaders in United States exports and, second, because theft of valuable IP assets is rampant worldwide. IP theft of video and audio content mostly includes counterfeiting, illegal reproduction, over production of discs, piracy, bootlegging and nowadays, illegal Internet file distribution, and it is international in scale and scope.

In the case of the motional visual arts, games and audio, the advent of the CD video (CDV), and now the Digital Versatile Disc (DVD), High-Definition DVD (HD-DVD), Blu-ray discs (BD), High-Definition television (HDTV) and other new technologies have exacerbated the problem.

One aspect of Intellectual property concerning video and audio content is that it provides enjoyment, entertainment and often education to the recipient. Various systems are in place today to enhance this experience. In order to provide such enhancing experiences, Intellectual Property rights associated with video and audio contents are identified in each individual case. Without such identification, additional information, such as dates of creation, information about the performing artists, copyright information and a myriad of other information that the recipient may want to know, cannot be supplied.

For these other reasons, there is a need for a simple and speedy way to identify Intellectual Property in general and, more particularly, Motional Media.

The present invention is directed to solving one or more of these problems since in at least one embodiment, prior processing of the media is not involved and/or, therefore, there are no codes to bury. Furthermore, in alternative embodiments, the present invention detects media identities, irrespective of format, quality, origin such as bootleg, editing and other changes to, or abuses of, the original production. The present invention can identify, for example, movies that run backwards in time, movies that are displayed upside down and/or at an angle.

3. Description of Prior Art

Various methods have been devised to identify Intellectual Property with varying degrees of success. One well-known technique has been the use of “Watermarks.”

Watermarking seeks to “bury” a secret code in the visual media that is invisible to the eye. In some instances, watermarking embeds a secret code in the audio that is inaudible to the ear. The secret code is then rediscovered by processing the content with a mathematical algorithm. In many proposals the necessary computation rate has been high since they often involve Discrete Cosine Transforms (DCT's) or Fast Fourier Transforms (FFT's), and associated refinements of these well known computational methods. They have been adapted to speed up the process, and give increased robustness against circumvention and visibility. In such adaptations, the watermarks have been compromised.

The code can also be configured in many ways to include IP details of the associated media. These technologies have been proposed by many, including the principal companies of the DVD Forum. One aspect of Intellectual property concerning video and audio content is that it provides enjoyment, entertainment and often education to the recipient. Various systems are in place today that enhance this experience. In order to provide such enhancing experiences, Intellectual Property rights associated with video and audio contents are identified in each individual case. Without such identification, additional information, such as dates of creation, information about the performing artists, copyright information and a myriad of other details that the recipient may want to know, cannot be supplied.

For these and other reasons, there is a need for a simple and speedy way to identify Intellectual Property in general and, more particularly, Motional Media.

Unfortunately there are several severe limitations to the existing types of system. The first is the difficulty of making the watermark invisible irrespective of the detailed nature of the content. The second is the amount of mathematical signal processing needed to extract the watermark and the information therein. Microprocessors of ever-higher power help to assuage this problem but require electronic support structures. Furthermore, hardware decoders and/or software must be incorporated in the receiving device. The third is that decoders are necessary that have a set of rules, either built-in or have other access to the information, to act on the extracted rules. Exemplary rules include no playing or copying allowed, one or multiple copies allowed, and the like. The fourth is that the watermarks are not robust to editing, or standards changes, for example, displays in Color that are transformed to Black and White (or vice-versa), HDTV to conventional 4/3, 5/4 or “letterbox”-ratio picture, time dilation or aspect ratio change, bootlegged copies etc., and other forms of manipulation. Watermarks are, in general, lost in many of these types of common processes. The fifth is that not all watermarks are robust in certain types of picture. For example, detailed structure of a given picture affects the detection ability of the watermark, or raising insertion level of the watermark in order to ensure detection increases the danger of the watermark becoming visible and, thus, interferes with the picture quality. The sixth is that watermarks do not generally have sufficient bandwidth to supply data to actually identify the work; they merely carry sufficient information related to copyright holder's permissions for use of work.

Furthermore, originals or bootleg copies of the original media can be made even before a watermark is inserted by the studio. In these instances, there is no information to de-code. There have been several recent cases where this has occurred with prominent movies. The present invention in accordance with some embodiments is directed to solving one or more of these watermark problems when prior processing of the media is not involved, when code is not buried, or when the media is un-readable.

Another technique described in the prior art that is used to identify motional and audio media is a method known as “fingerprinting.” These methods seek to emulate the uniqueness of the human fingerprint and apply similar concepts to motional and audio media. The system applies a mathematical algorithmic technique to derive short identifiers from the media by using what is designed to be a significant perceptual assessment of the content. Therefore different researchers have their own ideas on the importance of various perceptual parameters and build an algorithm to derive measurements in question. Unlike the human fingerprint in which one is a sufficient and complete identity, because media varies as a function of time, fingerprints are derived throughout the work, so that discovery can occur wherever the search starts. The concept is to reduce the amount of data for the fingerprints when compared to that of the original work. When a fingerprint is obtained, it is compared with those from the same work in a database and if a match is obtained an identity is discovered.

The problem with this methodology is that the derivations of the fingerprint by the prior art methods require considerable processing by the algorithm. A useful number is the ratio of the total fingerprint data for a file compared to that of the original. Compression ratios so obtained are anything from about 50 to one for an MP3 or MPEG-4 file to about a thousand to one, that depends on several factors such as how significantly the original file was bit-rate reduced. At these ratios the database holding the reference fingerprints for a million files is very large, especially for motional media, and search times are extended. Furthermore the processing involved to derive the fingerprint is intensive and cannot ran easily at a rate that is faster than real time. Conventional fingerprint technologies derive unique identifiers by processing pictures or a group of pictures. These systems derive what is hoped to be a unique set of coefficients or numbers that can be used to identify unknown content by a search in an appropriate database. However, in a large library, for example, with a million titles, the number of fingerprints that are derived or may be derivable can run to several hundred billion or up to a trillion or more. Although the pictures are derived from infinite sources, many fingerprints, in practice, will be fairly similar because majority of pictures will be of average brightness, gain, color, hue and saturation for instance. This is generally not a problem with perfect sources and content. However, when the source is distorted, for example by changes in format, by reduced quality, boxing of the display, blurred camera derived pictures or angular distortions of the images or other added components such as sub titles in different languages, the conventional methods can get into difficulties.

### SUMMARY OF EMBODIMENTS OF THE INVENTION

A system and method is described to generate unique motional visual media identifiers in the form of a series of numbers and/or characters that are a fraction of the size of a conventional movie, television program, advertisement, computer games software or any form of motional visual media. One or more embodiments of the invention generates unique motional visual media identifiers without pre-processing or insertion of any code or other form of message in the original media. Furthermore, it operates successfully with any source under detection, including ones with edits, format change, color or black and white or a bootleg, irrespective of the original form of presentation of the media. One or more embodiments of the invention do not require a file that is identical to the original file, as long as the file includes same basic but not necessarily complete artistic content as the original. The identifiers are calculated and detected using a minimum of processor computing power and storage capacity so that detection of an identity, or the reference entry to the master database, can occur at many times real time. The present invention describes a system and method to fulfill one or more of these requirements.

The present invention addresses and applies novel technology to alleviate one or more of the aforementioned problems. The present invention solves one or more of these problems in accordance with some embodiments by deriving a fingerprint using a method that allows very high compression ratios for data capacity of a fingerprint file compared to data of an original media file. For example, the ratio may be as high as a million to one for compressed motional media should full advantage of the system is used (or up to tens of millions to one for uncompressed media). The present invention, in alternative embodiments, includes a simple algorithm that it can execute faster than in real time. Furthermore, the present invention, in alternative embodiments, can detect media identities, irrespective of format, bootleg, editing and other changes to or abuses of the original production. In some embodiments, the present invention can identify movies that are run backwards in time, movies that can be displayed upside down and/or at an angle, and/or movies that can be taken by a camera, and the like.

Embodiments of the present invention are directed to providing increased robustness in shot change detection of extreme picture environments that are informal recordings and/or with substantially extremely poor quality excerpts. One or more embodiments of the present invention is directed to fast identifications of the original work by analysis of high quality excerpts that use substantially the same database records as analyzed for the whole of the master original recorded copy.

Another embodiment of the present invention is directed to accommodating fast movement in poor quality samples by over-riding frequent short “nominally false” shot changes due to rapid movement, average brightness flashes, etc.

One optional purpose of the present invention is to improve the detection of cuts, shot or scene changes in a wide range of the actual picture content from motional media sources. More particularly, one optional purpose of the present invention is to improve the detection of cuts, shot or scene changes in motional media sources that have been subject to distortions of various types, or have been cropped or otherwise interfered with when compared to the original.

Another optional purpose of this invention to allocate time codes at shot changes referenced to the beginning of the media, so that excerpts are not only identified, but are also known as to where and when they occur relative to the start of the complete original media.

Yet another optional purpose of this invention is to improve the operation and robustness of the picture count, timing and vector acquisition methodology for a wide range of possible sources of varying quality, particularly those with widely differing brightness and/or those with flash frames and/or with rapid movement.

Yet another optional purpose is to ensure that for all practical purposes a level of reliability with an extremely small probability of error is obtained for the identity of the original media from a measurement of an excerpt irrespective of its changes in quality or other edits compared to those factors in the original.

Another optional purpose of this invention is to identify an unknown media even when one to one match of the identity vectors are not obtained.

Yet another optional purpose of the invention is that the copyright and media ownership, permissions and other information associated with a particular work is available from a local or remote or like database.

Yet another optional purpose of the present invention is to identify virtually all the motional media that has ever been created provided a master or copy of the original is available and has been logged in the database(s).

Yet another optional purpose of the invention is to create fingerprints that require only small amount of vector data, so that a database having a relatively small data capacity can optionally include identities of all motional media.

Yet another optional purpose of the invention is to enable fast database search capabilities by creating fingerprints with small amount of vector data that is required for each fingerprint.

Yet another optional purpose of the invention is to use a robust yet simple algorithm to achieve these objectives with minimum processing power, so that fingerprints can be generated at speeds that optionally exceed real time.

Yet another optional object is to identify any unknown media in the shortest possible time.

Yet another optional object is to incorporate adaptive filters to increase the robustness of the system with signals containing rapid movement.

These and other purposes of the spirit and claims of the invention will be known to anyone skilled in the art.

Accordingly, in at least one embodiment, the present invention relates to a system and method to identify motional picture media. The method includes the operative sequential, sequence independent and/or non-sequential steps of: deriving synchronization pulses at content rate of a first motional picture media; storing picture(s) from the first motional picture media content, wherein the storing is actuated by synchronization pulse(s); selecting at least one of the plurality of stored pictures; comparing at least one of the selected picture with at least one of adjacent pictures of the first motional picture media; removing filter components from a signal(s) selected from the compared picture(s); detecting an indicia for at least one change in properties of at least one of the adjacent pictures content; adjusting a threshold value of the adjacent picture content properties based on the detected indicia; and storing the adjusted picture(s) in a database. The method also includes the step of deriving first vector(s) of the adjusted picture(s) from the first motional picture media. The adjusted picture(s) is a sequence, and the first vector(s) of the adjusted pictures are between shot changes. The method further includes the steps of comparing the first vector(s) with second vector(s) of picture(s) from a second motional picture media; determining whether the first vector(s) is substantially similar to the second vector(s); retrieving identity data corresponding to the second motional picture media if the first vector(s) is substantially similar to the second vector(s); and displaying the retrieved identity data corresponding to the second motional picture media. More particularly, the identity data comprises ownership and copyright information.

One or more embodiments of the present invention also provides for restricting use of second motional picture media if first vector(s) is not substantially similar to the second vector(s); retrieving copy control data corresponding to the second motional picture media; and displaying copy control information corresponding to the copy control data.

Another embodiment of the present invention, optionally, enables selection of at least two pictures from the plurality of stored pictures. In one embodiment of the present invention, the threshold value prevents false shot change detections when the detected indicia, for changes in properties of at least one of the adjacent pictures content, is a substantially low value.

In one embodiment of the present invention, the first and second vectors are counts of the pictures between shot changes. In another embodiment of the present invention, the first and second vectors are time codes between shot changes.

One or more embodiments of the present invention further enables retrieving ancillary data associated with identity data corresponding to the second motional picture media. Optionally, the ancillary data comprises date of production, date of copyright, artists, director, producer and locations used in the work.

One or more embodiments of the present invention further provides that the first and second vectors is assigned zero counts, wherein the zero counts triggers a data reduction. Optionally, the of first and second vectors is assigned at least two successive zero counts, wherein the at least two successive zero counts triggers recognition of ancillary data.

In alternate embodiments of the present invention, the copy control information is at least one of: Copy Never: Pre-Recorded Media, No Home Use, and Copy Never: Trusted Source. In one embodiment of the present invention, the motional media is at least one of: movies, video games, computer games, television programs, advertisements, graphics and music videos.

Alternate embodiments of the present invention also provides resetting the first vector(s) of at least one of the plurality of adjusted pictures from the first motional picture media; deriving the reset first vector(s) of the adjusted pictures from the first motional picture media; and storing the at least one of the plurality of reset first vectors.

In some embodiments of the present invention, the picture content properties are brightness, the indicia for a change in one of the pictures content properties is low brightness, flicker, or rapid picture movement.

In alternate embodiments of the present invention, the filter component is low frequency filter or multi-dimensional pixels.

Alternate embodiments of the present invention further enables restoring a DC offset of at least one of the signals selected from at least one of the compared pictures. Optionally, the signals include either color signal components and luminance component, or Chroma signal components and Luma component.

One or more embodiments of the present invention are also related to a system for identifying motional picture media content. The system includes a programmable storage media comprising a first motional picture media; a synchronization device for deriving at least one of a plurality of synchronization pulses at content rate of a first motional picture media; an actuator for actuating at least one of the plurality of synchronization pulses, wherein the at least one of the plurality of actuated synchronization pulses actuates storing at least one of a plurality of pictures from the first motional picture media content; a subtractor for comparing at least one of the selected picture with at least one of adjacent pictures of the first motional picture media; a low-pass filter for removing filter components from at least one of a plurality of signals, the at least one of the plurality of signals is selected from at least one of the compared pictures; a detector for detecting an indicia for at least one change in at least one of a plurality of properties of at least one of the adjacent pictures content; and a variable gain element for adjusting a threshold value of at least one of the plurality of adjacent picture content properties based on the detected indicia. The system also includes a storage device for storing at least one of the plurality of adjusted pictures; and a media player for deriving at least one of a plurality of first vectors of at least one of the plurality of adjusted pictures from the first motional picture media, wherein the plurality of adjusted pictures is a sequence, and wherein the first vectors of the adjusted pictures are between shot changes. The system further includes a first processor for comparing the at least one of the plurality of first vectors with at least one of a plurality of second vectors of at least one of a plurality of pictures from a second motional picture media; a second processor for retrieving identity data corresponding to the second motional picture media, wherein the at least one of the plurality of first vectors is substantially similar to the at least one of the plurality of second vectors; and a display device associated with the media player for displaying the retrieved identity data corresponding to the second motional picture media.

Optionally, the present invention provides that the media player is capable of reading and/or writing at least one of: CD video (CDV), Digital Versatile Disc (DVD), High-Definition DVD (HD-DVD), Blu-ray discs (BD), Digital Video Recorder (DVR), Random Access Memory (RAM), Read-Only Memory (ROM), magnetic storage media, or a flash memory device. In one embodiment, the media player analyzes content of the programmable storage media in about real time. In another embodiment, the media player is capable of analyzing content of a motional media stored on a remote database accessible via the Internet.

Another embodiment of the present invention provides a method for identifying motional picture media content including the steps of deriving at least one of a plurality of synchronization pulses at content rate of a first motional picture media; selecting at least one of the plurality of stored pictures; comparing at least two of the selected picture with at least one of adjacent pictures of the first motional picture media; detecting an indicia for at least one change in at least one of a plurality of properties of at least one of the adjacent pictures content; and adjusting a threshold value of at least one of the plurality of adjacent picture content properties based on the detected indicia. The method also includes deriving at least one of a plurality of first vectors of at least one of a plurality of pictures from a first motional picture media, wherein the plurality of pictures comprises a sequence of the first motional picture media, and wherein the first vectors of the pictures are substantially between at least one of shot and/or event changes of the first motional picture media; and resetting at least one of the plurality of first vectors of at least one of the plurality of adjusted pictures from the first motional picture media. The method further includes the steps of deriving at least one of the reset first vectors of at least one of the plurality of adjusted pictures from the first motional picture media; storing the at least one of the plurality of reset first vectors; searching at least one database for a second motional picture media, wherein the second motional picture media is substantially similar to the first motional picture media with reference to said identifying; and controlling use of the first motional picture media responsive to a comparison of the at least one of the plurality of first vectors to at least one of a plurality of second vectors of at least one of a plurality of pictures from the second motional picture media.

One or more embodiments of the present invention further provides the steps of restricting use of the first motional picture media if the at least one of the plurality of first vectors is not substantially similar to at least one of a plurality of second vectors of at least one of a plurality of pictures from the second motional picture media; and displaying copy control information corresponding to the second motional picture media to a user for controlling access to the first motional picture media.

Optionally, the present invention further provides the steps of adjusting an average of at least two of the plurality of properties of at least two of the adjacent pictures content to yield a substantially constant value.

Another embodiment of the present invention provides a method for identifying motional picture media content including the steps of deriving at least one of a plurality of synchronization pulses at content rate of a motional picture media; determining at least one change in at least one of a plurality of properties of at least one of a plurality of pictures compared to at least one of adjacent pictures, wherein at least one of the plurality of pictures is selected from the motional picture media; adjusting at least one of a plurality of properties of at least one of the adjacent pictures content; and resetting at least one of a plurality of vectors of at least one of the plurality of adjusted pictures from the motional picture media, wherein resetting is actuated by at least one of the plurality of synchronization pulses. The method further includes the steps of deriving at least one of the reset vectors of at least one of the plurality of adjusted pictures from the motional picture media; and controlling use of the motional picture media responsive to a comparison of at least one of the plurality of the reset vectors with at least one of a plurality of original vectors from original motional picture media, wherein the reset and original vectors are substantially between at least one of shot and/or event changes of the motional picture media and the original motional picture media.

Yet another embodiment of the present invention provides a method for identifying motional picture media content including the steps of deriving at least one of a plurality of synchronization pulses at content rate of a varying media; determining at least one variation in at least one of a plurality of properties of at least one of a plurality of frames compared to at least one of adjacent frames, wherein at least one of the plurality of frames is selected from the varying media; and resetting at least one of a plurality of vectors of at least one of the plurality of adjusted frames from the varying media, wherein resetting is actuated by at least one of the plurality of synchronization pulses. The method also includes the step of adjusting at least one of a plurality of properties of at least one of the adjacent frames content. Embodiments of the present invention provide systems and methods to identify motional picture media that include, for example, means to derive synchronization pulses at picture rate; means to store at least one picture; means to subtract at least one picture from an adjacent picture; means to low pass filter the output from the subtracter to remove two dimensional high frequency components from the differential signals; means to detect the level from the low pass filter to establish sudden changes in the content of adjacent pictures by triggering the threshold detector; means to set a minimum level and vary the trigger level in the said level detector according to at least one or more properties of the picture content; means to reset a digital counter to zero or store its accumulated count; means to make the counter count pictures between resets or continue to count; means to store the maximum values of the counts just before reset or the accumulated count values; means to locally store a sequence of the derived counts or accumulated values; means to have a master database loaded with the measurements from originals or copies of the works to be analyzed; and means to enter copyright, ownership, permissions and other data concerning each individual work in the master database. One or more embodiments of the present invention further includes a time code clock that may or may not be reset but whose time is recorded at the shot change event.

One embodiment of the present invention includes two or more picture stores. In another embodiment of the present invention, a second picture store is placed before the first picture store to derive optimum settings for the trigger level in said threshold detector. Yet another embodiment of the present invention sets a minimum value of offset in the trigger level in said threshold detector to avoid false detections when the brightness level of adjacent pictures are very low in value.

Another embodiment of the present invention uses the second picture store to integrate the summed average level of two adjacent picture's brightness and attenuates the value so obtained that is then added to the aforesaid off set and thereby further adjusts the trigger level in said threshold detector.

Yet another embodiment of the present invention employs a sample and hold device to look ahead and maintain the level to the threshold detector until the following picture sync pulse so that the threshold detector trigger level is fixed by the same two summed pictures that are subtracted from the first picture store

A system, in accordance with one or more embodiments of the present invention, subtracts the input from the output of the second picture store that is then attenuated and limited in range, sampled and held and modulates or adds to the trigger signal level for the threshold detector to improve the robustness of the system when the content has pictures of rapid movement in adjacent pictures.

One or more embodiments of the present invention provides a system that incorporates variable gain elements in series with the integrated signals from the second picture store so that the average brightness level of two adjacent pictures are individually adjusted automatically to be approximately constant relative to a given reference level.

One embodiment of the present invention provides means to limit said range of brightness adjustment in each variable gain element. Another embodiment of the present invention provides means to have a suitable law governing the input and output gain ratio versus the level of the input or output signal. Yet another embodiment of the present invention provides means to hold the value so set for one picture period while the pictures that are adjusted for brightness pass through the first picture store. Yet another embodiment of the present invention provides means to derive the sum of said adjusted signals and attenuate said sum and use the signal to adjust the trigger level in the threshold detector.

One or more embodiments of the present invention provides a system that allows the trigger level of the threshold detector to vary throughout the picture that includes at least two variable gain elements that have as input two adjacent pictures from the second picture store; at least two low pass filters whose cutoff frequency is arranged to allow very low frequency or signal components such as caused by flicker to operate said variable gain elements; means to sum and attenuate the output of the variable gain elements; means to either prevent or limit the range of adjustment of the trigger level in the threshold detector.

One embodiment of the present invention includes means to arrange the low pass filter to remove multi-dimensional pixels or high frequency components that are a few percent of the pixels both horizontally and vertically and in all two dimensions of the picture that are output of the main subtracter and have a relatively slow roll-off from the pass band to the stop band so that the digital processing computation for the filter is at a minimum and said filter has a minimum of stages. More particularly, the filter is used for both the removal of high frequency picture components of the differences between adjacent frames and the removal of the high frequency components that are caused by sub-titles, symbols or other characters from any language, which are in the picture and that change or move between frames.

Another embodiment of the present invention provides a system that incorporates two dimensional adaptive low pass filters whose cutoff frequency is governed by the rapidity of the movement and the amplitude of the output signal from the integrated look-ahead subtracter and sample and hold, the said filters reducing in bandwidth as the rapidity of the movement and the difference between adjacent pictures increases.

Yet another embodiment of the present invention provides means to incorporates two dimensional adaptive filters that are scaled by look up tables, or other suitable means, for the coefficients which aforesaid table is chosen by means of the amplitude of the difference signal from the look-ahead subtracter.

A system, in accordance with one or more embodiments of the present invention, incorporates a means of limiting the range of the said difference signal amplitude and by this means the range of the cutoff frequency of the filters.

One embodiment of the present invention provides means of processing the picture count of low vector numbers during content with rapid movement so that any number below a given value is not logged in the main database but is accumulated and added to the next vector that is higher in value than the said given value.

In one embodiment of the present invention a given value that is not logged in the main database is a variable according to the genre of the content, so that the given number has low values for fast moving or content with frequent shot changes, and is rather higher for content that slow movement or less rapid frequency of cuts.

Another one embodiment of the present invention provides means for identifying the genre of the content by the classification of the statistics of the content such as the percentage ratio of cuts to the total pictures or the frequency of scenes with rapid movement as functions of the total pictures in aforesaid content.

Yet another one embodiment of the present invention provides a system that exploits the forbidden counts of zero up to the aforesaid given low value vector number in claim 14 to indicate the start and end of the insertion of special data in the vector bit stream so as to differentiate such data from the normal identifier vectors in the bit stream. One embodiment of the present invention processes color signal components separately from composite and or Luma component before derivation of the vector count.

In one embodiment of the present invention the locally derived picture sync pulses are replaced by a free running accurate clock at the picture rate. For example, fractional seconds, minutes and hours are derived from the clock. In another embodiment of the present invention, fractional time differences between shots can be used to achieve substantially the same result.

Another embodiment of the present invention analyzes video and computer games, TV programs, advertisements, movies and other sources of visual motion picture content

Yet another embodiment of the present invention analyzes motional media from disc, a visual camera, or electronically on the Internet, or from any source, whether the analysis is in real time, or faster or slower than real time.

There has thus been outlined, rather broadly, the more important features of the invention in order that the detailed description thereof that follows may be better understood, and in order that the present contribution to the art may be better appreciated.

There are, of course, additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting. Further, it is to be understood that embodiments of the present invention can be implemented using analog and/or digital signal processing techniques.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way. These together with other objects of the invention, along with the various features of novelty that characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there is illustrated preferred embodiments of the invention.

### BRIEF DESCRIPTION OF THE DRAWINGS

The Detailed Description including the description of preferred systems and methods embodying features of the invention will be best understood when read in reference to the accompanying figures wherein:

FIG. 1 is a block diagram illustrating threshold detector offset.

FIG. 2 is a block diagram illustrating derivation of summed mean brightness of adjacent pictures.

FIG. 3 is a block diagram illustrating mean brightness adjustment of adjacent pictures using variable gain elements.

FIG. 4 is a block diagram of a flicker reduction system using a dynamic variable gain element.

FIG. 5 is an exemplary illustration of the effect of slow and fast movement on adjacent pictures and the action of the low pass filter.

FIG. 6 is a block diagram illustrating modulation of the trigger level in the threshold detector to reduce sensitivity to fast movement.

FIG. 7 illustrates an exemplary system for flicker reduction, summed mean brightness adjustment and reduced sensitivity to movement in pictures

FIG. 8 is a flow diagram illustrating the use of a second counter to accumulate and add low value counts to the main first counter

FIG. 9 is a graphical illustration of frequency characteristics in decibels of four example low pass filters each separated by an octave

FIG. 10 is a graphical illustration of frequency characteristics of the same filters with a logarithmic vertical axis in milli-volts peak to peak.

### DETAILED DESCRIPTION OF EMBODIMENTS OF THE INVENTION

The following discussion is presented to enable a person skilled in the art to make and use the invention. The general principles described herein may be applied to embodiments and applications other than those detailed below without departing from the spirit and scope of the present invention. The present invention is not intended to be limited to the embodiments shown, but is to be accorded the widest scope consistent with the principles and features disclosed or suggested herein.

Before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the invention be regarded as including equivalent constructions to those described herein insofar as they do not depart from the spirit and scope of the present invention.

For example, the specific sequence of the described process may be altered so that certain processes are conducted in parallel or independent, with other processes, to the extent that the processes are not dependent upon each other. Thus, the specific order of steps described herein is not to be considered implying a specific sequence of steps to perform the process. Other alterations or modifications of the above processes are also contemplated. For example, further insubstantial approximations of the process and/or algorithms are also considered within the scope of the processes described herein.

In addition, features illustrated or described as part of one embodiment can be used on other embodiments to yield a still further embodiment. Additionally, certain features may be interchanged with similar devices or features not mentioned yet which perform the same or similar functions. It is therefore intended that such modifications and variations are included within the totality of the present invention.

As used throughout the disclosure, the following terms, unless otherwise indicated, shall be understood to have the following meanings.

“Picture” or “Frame” refers to a generic term for the file or display of a complete picture in the content. Specific variations may be described and only applied to a given particular scenario.

Picture and Frame are defined as a single picture from a photocopy film that is often used in projection movie theatres or telecine's and/or the electronic equivalent. Picture and Frame are also defined in interlaced television such as HDTV, NTSC, SECAM or PAL as two successive interlaced fields.

A “Field” refers to an interlaced TV signal in one scan, the next field interlacing with the first to produce a complete picture or frame from them both.

In progressive scan TV or some forms of HDTV, picture is defined as one scan. (In systems without interlace.) This is also the normal way that computer video monitors operate.

A “shot” is the common parlance in the moving pictures business, (Movies and TV), defining a specific time for one (or more) cameras and/or picture sources to produce a specific scene. The next shot is of a change in scene.

The concept of “Shot Change”, “Scene Change,” “Event” or “Cut” is very important for this invention.

“Shot Changes” refers to when one shot or scene is ended, and an edit cuts to the next shot or scene. This may be done by a cut, fast fade, wipe or cross fade. (The latter involves changing the picture between two different scenes, as one is faded out the other is faded in.) For the purpose of this invention a shot change is defined as a cut or edit between two different scenes. In some embodiments, a shot change may be a blank, or a picture with no information, between two different scenes. This is often referred to as “Black” level, colored, grey or “White” level.

“Sync” is the common abbreviation for synchronize, and means the time alignment of signals or for operations on signals. The use of the term synchronization pulses at picture rate refers to one such enabling technique. More particularly, sync refers to pulses that are timed to occur after a picture scan is completed, just before, or at the start of the next time successive picture, Sync also refers to a sync pulse timed to be within the picture “fly-back” or frame interval.

In some examples illustrating methods in accordance with one or more embodiments of the present invention, typical shot change time could be about six seconds, one picture, or several pictures. For example, it is common in music videos or advertisements to observe many shot changes per second, whereas in a TV news program shots of an announcer may last several tens of seconds. It is the nature and artistic creation of the content that determines the number of pictures in a shot. The value of six seconds is therefore merely used as a typical media illustrative example without implying any restriction on the inventive concepts described herein.

The number of pictures per second also varies widely depending on the technology and method of display. Shot changes are recorded by a picture, and/or time, counter and the successive total picture counts or time between shot changes are frequently referred to as counts, numbers, times or generically “Vectors” in this application.

Embodiments of the present invention operates by deriving a continuous sequence or set of numbers that are the counts of the pictures or the number of fractional second times between shot changes. For certain motional media sources, shot changes may be either missed or erroneously detected. Such events do not defeat systems in accordance with one or more embodiments of the present invention because, as illustrated for example in co-pending application 60/786,812, which is incorporated herein by reference in its entirety for all purposes, erroneous vectors using fuzzy logic or other means are arranged to successfully obtain an identity. Such system merely requires that sometimes more vectors be measured. However, erroneous or missed detection of shot changes may increase time required to correctly identify the content under review. Furthermore, when content is manipulated by, for example, re-scanned from a visual screen or display surrounded by an electronically inserted box, erroneous vectors will tend to increase in number under certain conditions of the content. Embodiments of the present invention improves the accuracy of a shot change detection method for varying picture content that are present before and after a shot change. Other embodiments of the present invention improves the accuracy of a shot change detection method for varying types of scene that are present before and after a shot change. For example, average brightness of scenes could be characterized as low level (e.g., night time scenes), medium brightness (e.g., majority of scenes), and high brightness (e.g., bright sky, desert and snow scenes). In the above examples, average or integrated mean amplitude of each picture in the video signal is the significant variable. It is possible to have a shot change between scenes of any category, for example, a high brightness scene to a night scene or vice versa, a night scene to a medium brightness scene, and the like.

Average brightness or amplitude of a scene can have any value from black (e.g., Black level in video) to maximum white (e.g., peak white in video). Average brightness, as discussed herein, means the integration and averaging of all the brightness values of the pixels making up the scene. Colors in scenes will also have any integrated and averaged value, from zero to maximum saturation. These integrations may be applied to composite signals to include the Luma and Chroma components, or they may be separately and individually applied and/or combined in an adder.

Methods and results of subjective effects are discussed in prior art literature that relate brightness to human perception. One purpose of the present invention is to clarify that shot change detection is an electronic process and it is a mathematical derivation of the average brightness values that are the subject matter discussed herein. For example, parameter Gamma, the transfer law governing the video signal amplitude to the display brightness characteristic, also affects both the human perception and electronic distribution of brightness as a function of video signal level.

In eight bits per sample digital video system there are theoretically about 256 levels of brightness that can be transmitted and optimally displayed. This results in a signal to noise ratio of about 48 dB that depends on a sampling rate relative to the low pass filtered or displayed bandwidth. For color difference signals, different factors and bandwidths apply. Therefore, average picture brightness can vary widely, for example with a ratio of about 240 to one. Often, there are ten or more bits per sample of content and MPEG2-4/H.264/AVC encoded pictures, resulting in improved signal to noise ratio and values for Luma and Chroma or color components of the picture. Systems, in accordance with one or more embodiments of the present invention, achieve a high degree of data compression and yet maintain high quality. Studios also work with 4:2:0 or 4:2:2 component signals and other ratios representing the one Luma and two Chroma signals respectively.

In one or more embodiments of the present invention, difference is taken continuously between successive pictures. During a scene, this difference is usually small, and at a shot change this difference is larger. Thus, the output exceeds the threshold of a level detector, actuates storage of count and/or time, reset picture and time counters, and/or record event accumulated counts and time. Actual picture count, and/or duration in seconds, of the shot can be calculated by successively subtracting the stored values for adjacent shot changes. After picture-by-picture, or group of pictures by group of pictures subtraction, and low pass filtering, difference signal has its DC value re-established or restored by setting the largest negative value to zero.

Methods, in accordance with one or more embodiments of the present invention, can be used to detect a shot or scene change, wherein the result will be a certain indication that such an event has occurred. Indications of a shot or scene change may vary in apparent amplitude or apparent significance. In general, larger the indication greater is the confidence that an event has occurred. However, such a conclusion is miss-leading because event amplitude indications will be small for scenes with low average brightness of the successive pictures or groups of pictures at a shot change, when such scenes should have the same levels of confidence caused by high brightness pictures. Therefore, the scale that determines confidence in events must be a variable scale proportional to the properties of the pictures before and after a scene change.

One factor affecting threshold detector is input pictures containing interference or random noise. If the noise is, for example random and spectrally “white,” picture subtracter will increase the noise level by about 3 dB. For semi coherent interference, picture subtracter may increase noise level to about 6 dB. It is important that these interferences do not falsely trigger the detector. In some embodiments of the present invention, threshold detector has a minimum offset value, even if the average picture brightness component of the offset voltage is very low and near to zero. For example, a reasonable value for this offset is from about 25 to about 35 dB below the peak picture signal level. In other embodiments of the present invention, offset voltage can have any value. However, a picture with a signal to noise ratio less than about 25 to 30 dB becomes virtually unusable, or is of low entertainment value.

In an analog video signal having normal peak signal value of about 700 milli-volts and a black level value of about zero volts, a peak Signal to Noise ratio of 34 dB corresponds to about 14 milli-volts, a reasonable value for the offset. Amount of offset can be chosen at will based on expected quality of content. For example, amount offset values could be from about 1 milli-volts to about 38 milli-volts. Lower values could be chosen for HDTV and very high quality film sources, and larger values for rescanned displays, ant-piracy and bootleg operations in the field where it would be expected that the signals contain noise, interference and/or flicker.

FIG. 1 illustrates an exemplary system for implementing a threshold detector offset level. Input signal is delayed one picture by store 100, whose output provides an input to main subtracter 101. Another input to subtracter 101 is from the input signal. Subtracted picture output is applied to a low pass two dimensional filter 102 to remove high frequency components produced by small horizontal movement, vertical movement, or picture differences in any picture plane. AC signal from filter 102 is DC restored at “DC Restorer” or “Peak negative DC zero clamp” 103 by setting peak negative amplitude of the signal to zero. DC restored signal is applied to the threshold detector 104 that has an offset level above zero received from a DC offset source 105. In the absence of picture information or for very low levels of picture mean brightness, an offset prevents the detector from falsely triggering and producing a reset pulse output 106. In one embodiment of the present invention, amount of offset is adjusted to inhibit threshold detector 104 from detecting or erroneously triggering on noise present at the input.

Signal level to threshold detector will have varying values when two scenes at a cut have low, medium and/or high brightness. Certain types of shot-change (e.g., between two dark scenes) would not exceed a fixed level for threshold detector. However, content types without shot change (e.g., for very bright scenes) would not exceed a fixed level for threshold detector. To avoid this problem, one or more embodiments of the present invention provide a system that varies detector threshold according to average brightness or level of pictures before and after a shot change.

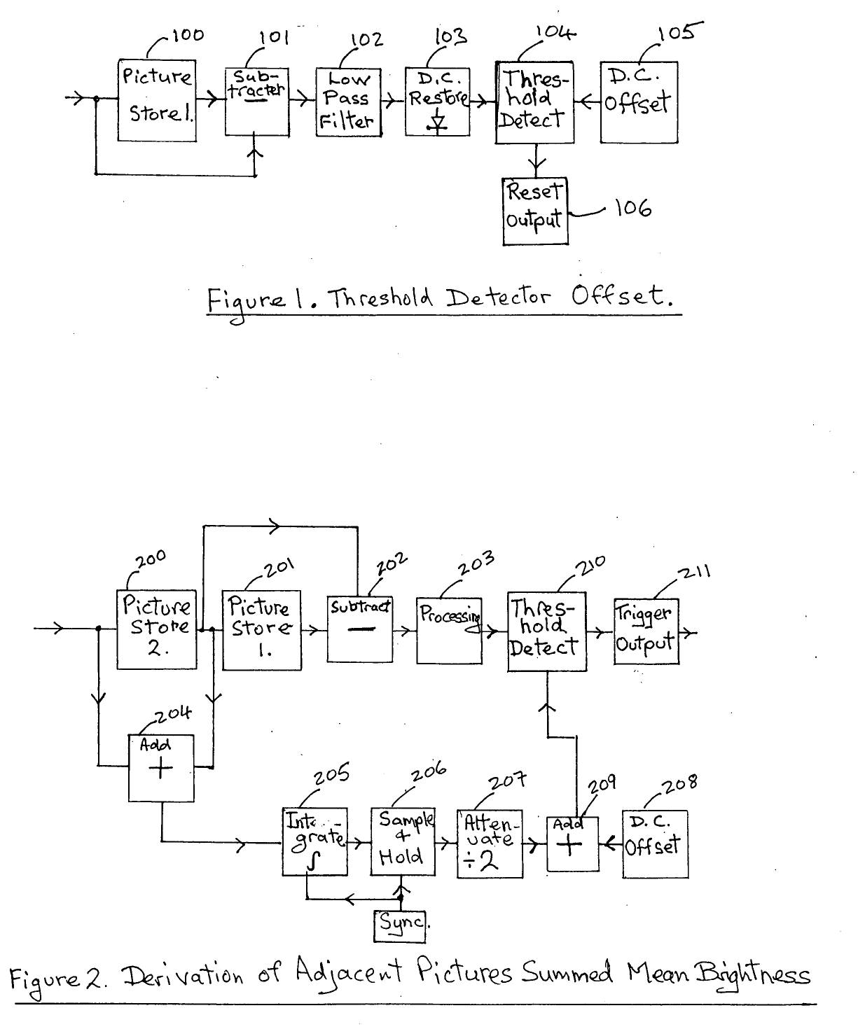

In one embodiment of the present invention, a second picture store is placed before a main first picture store that gives one input to a subtracter for determining picture differences. One or more embodiments of the present invention facilitate looking ahead at incoming pictures before they enter a main system store, a subtracter and remaining components of the system. FIG. 2 illustrates an exemplary system for derivation of adjacent pictures summed mean brightness. An input media signal is applied to a second picture store 200. An output from picture store 200 is applied to first picture store 201, an adder 204, and a subtracter 202. Adder 204 sums input media signal to second picture store and integrated output of second store 200 that has the immediately previous picture available. Summed output from adder 204 is integrated and averaged for the entire picture at integrator 205. The integrated signal from integrator 205 is sampled and held at component 206 operated by synchronizing pulses (“syncs”) at the picture rate. The syncs reset integrator 205 and sample and hold component 206 to zero while waiting for the next summed picture signal from adder 204 to be integrated at integrator 205. Thus, average brightness of two successive pictures are summed together. Combined output of first and second picture stores is integrated throughout each picture to obtain a combined mean or average brightness of the summed signal. Attenuator 207 normalizes amplitude of the summed signal by dividing its value by two. Adder 209 uses average summed brightness level from attenuator 207 to set trigger level 210 in threshold detector 104 by adding the normalized summed signal to the DC offset 208. The summed signal from adder 209 is used in threshold detector 104 to generate the threshold detector's trigger level at threshold detector 210.

Further, subtractor 202 derives a difference between the same pair of pictures used in determining the average brightness at attenuator 207. If the scene is constant, then the output from subtrator 202 will be a low value. If the pair of pictures is before and after a shot change, then output from subtractor 202 will be large, and the pre-adjusted threshold level, determined from the average level between the pictures at the shot change, will be at an improved value for optimal threshold sensitivity detection. In one or more embodiments of the present invention, a shot change can be between two pictures of low, medium and/or high brightness, and threshold for the detector is pre-adjusted to obtain sensitivity to detect a change in scene, especially for pictures with widely varying brightness before and after the cut. Processing unit 203 uses filter 102 and DC restorer 103 to remove high frequency components and then DC restore the derived output from subtractor 202. The processed signal is then provided as one input to threshold detector 104 for generating threshold detector's trigger level 210. Thus, the threshold's trigger level is set to the average integrated brightness of the two pictures that have been subtracted. Further, the level is optimized to find a shot change and assists to prevent the system from either missing a shot change or falsely finding one.

In another embodiment of the present invention, average brightness values of incoming successive pictures can be used to vary gains of the pictures such that the mean brightness is held constant at a fixed pre-determined reference value. A gain for each picture passing to the shot change detector may be adjusted automatically, picture by picture, so that all the pictures presented to the subtracter have a substantially constant mean brightness level. In one example of the present invention, a trigger threshold in the detector would also have a fixed value. Thus, the pictures are always of constant average brightness, and produce similar difference outputs even when the original pictures were of widely varying brightness. In some embodiments of the present invention, a gradual limit is placed on gain adjustment rather than achieving a perfect equality of the mean brightness. The transfer characteristics of variable gain systems in compressor-expander (“Compander”) and dynamic limiters have been known and studied for a long time for audio and video signals, in analog and digital signal domains.

An optimum system takes account of many factors present in input signals for the following reasons. First, a very low average brightness image could require a large gain to equal the referenced brightness. Although the average brightness of the image is initially very low, it may contain some small area peak or near peak brightness points in the picture. If the gain is raised considerably, these peak white areas will exceed the peak signal levels, will be clipped, or be subject to what is known as peak white crushed. This could give rise to false shot change detection. Second, raising the gain substantially with a noisy source signal may increase the noise level sufficiently to interfere with proper operation of the threshold detector. This would result in an uncertainty in the signal supplied to the threshold's trigger level. This would also cause the detection mechanism to sometimes trigger and other times not trigger depending on the quality of the source so producing false detections.

For these reasons, the range of gain adjustment should be moderated according to factors previously discussed, and according to factors that are well known and in the public domain. Alternatively, embodiments of the present invention can be used to reduce or avoid the problems outlined above by applying gain adjustment to increase or decrease the picture levels to asymptote to a mean common brightness level for both pictures. In such cases, the threshold level may require adjustment as well and can be achieved using embodiments of the present invention discussed earlier. In other words, the optimum system may incorporate both methods described above working in harmony.

Variable gain methods employ well known techniques to achieve the constant average brightness. Such methods include a measurement circuit that generates a reference gain signal followed by a sample and hold circuit that is actuated by picture synchronizing pulses. The sampled signal is passed to a variable gain element that changes the mean brightness of the picture in a predetermined linear or power law relationship. The variable gain element reduces the mean brightness of all pictures, having an initial widely varying brightness, to similar acceptable values.

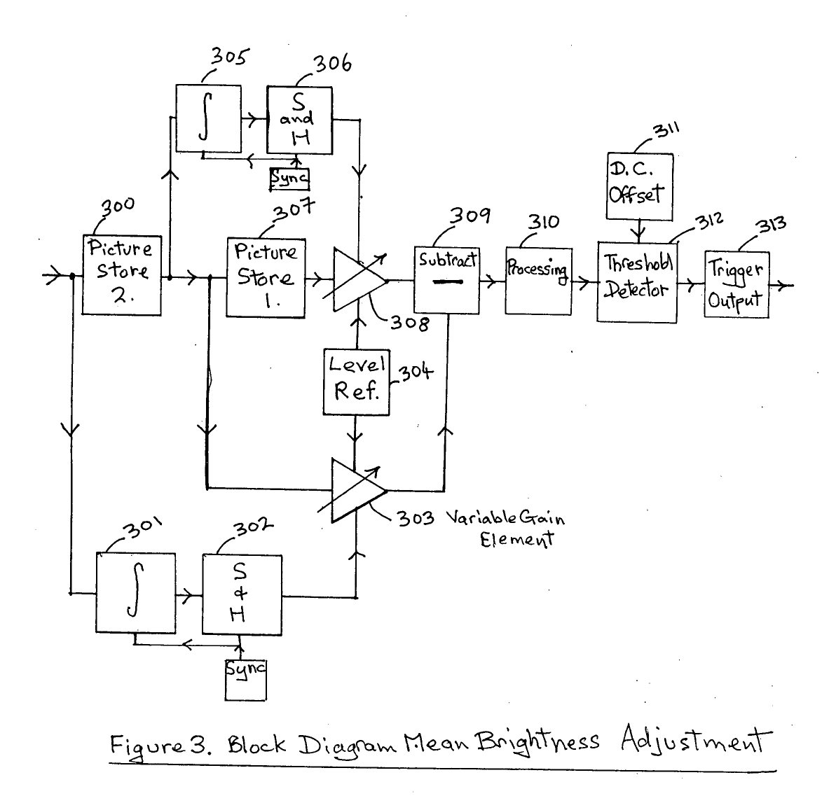

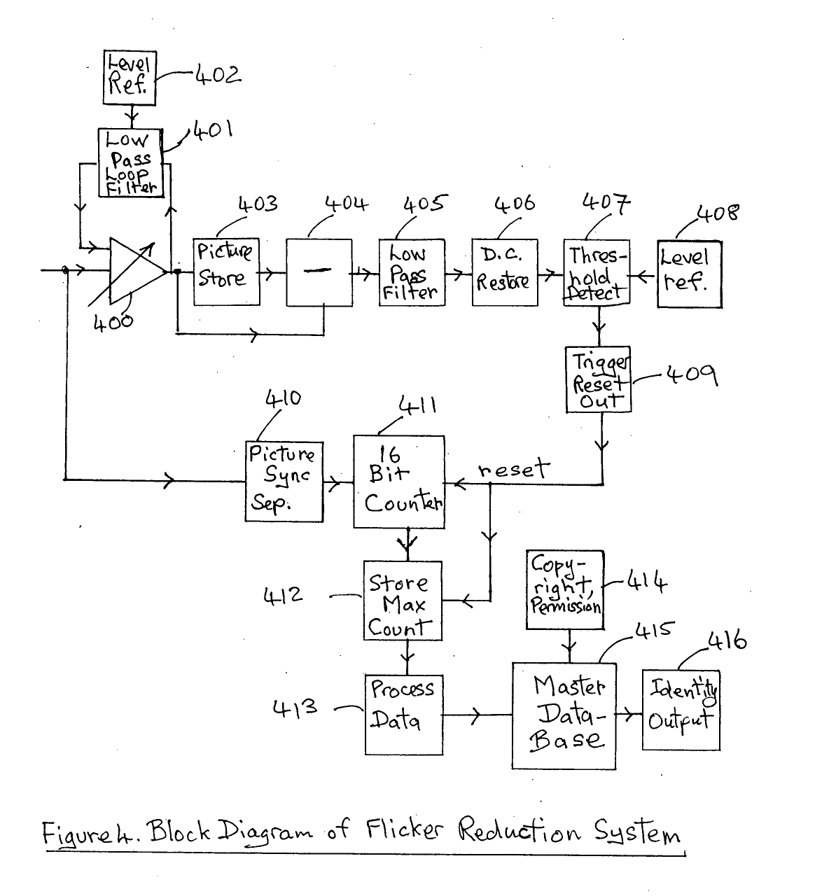

FIG. 3 shows a block diagram of an exemplary system, in accordance with one or more embodiments of the present invention, for mean brightness adjustment. An input signal is applied to picture store number two 300, and to an integrator 301 for integrating to obtain the mean value of the pixels of one picture. The mean value of the pixels or brightness is sampled and held by a component 302 operated by picture syncs. The syncs also reset the integrator 301 to obtain the mean brightness of the next picture. Integrated signal from component 302 is received by a variable gain element 303. Variable gain element 303 also receives, as input, the same picture used by integrator 305 for integrating signals emerging from picture store two 300. Further, integrator 305 also integrates previous picture from store number two 300, which is sampled and held in component 306 operated by picture syncs. The syncs also reset the integrator 305 to obtain the mean brightness of the next picture. Integrated signal from component 306 is coupled to a second variable gain element 308 receiving the output of picture store one 307. Both variable gain elements 303 and 308 adjust the brightness of the two pictures separately according to level reference 304 supplied to both elements. A difference between this reference level 304 and the value obtained by the integrators 301 and 305 adjust the gains to give a constant or nearly constant brightness at their outputs. These output pictures feed the inputs to the main subtractor 309, and its output feeds the processing unit 310. Processing unit 310 uses filter 102 and DC restorer 103 to at least remove high frequency components and then DC restore the derived output from subtractor 309. The processed signal is then provided as one input to threshold detector 312 for generating threshold detector's trigger level. In one embodiment of the present invention, DC offset 311 to the subtracter 309 is substantially set to be equal to reference level 304, which is equal to the mean brightness of the incoming pictures. When a shot change occurs the subtracted output is of large amplitude and produces a trigger output 313 from threshold detector 312. In one or more embodiments of the present invention, each picture to subtractor 309 is of about the same average brightness. This is because integration circuits look ahead respectively for each picture so that as each picture emerges from stores 300 and 307. This also because the average values have been just established, and the variable gain elements 303 and 308 raise or lower the gain according to the reference (brightness) level. In other embodiments of the present invention, reference trigger level 304 is fixed in threshold detector 312 to about the same level as the mean brightness level, since subtracting two dissimilar images (at a shot change) will double the peak amplitude of the signal that is derived and sent to the detector.

One embodiment of the present invention produces pictures of equal or similar mean brightness for supply to the main subtractor 309. Another embodiment of the present invention subtracts pictures that have a different mean brightness. In other embodiments of the present invention, unless scene changes to a picture happens to have the same mean brightness before and after the cut, gain of variable gain elements 303 and 308 will be set to the same value. In yet another embodiment of the present invention, threshold trigger level is adjusted to be an optimum of the mean of two adjacent pictures before they are passed to subtracter 309.

Embodiments of the present invention incorporating the variable gain elements, as shown in FIG. 3, can be used to improve the robustness of the system in exemplary situation described below. Illegal or “bootleg” copies of motional media originates from use of a camera pointing to a live screen usually at a movie theater or may be from a television screen. Movies are normally released initially in a theater so are not available on disc or TV until a later time. However, with movies made especially for television the reverse is true. In the case of a movie, the value of a bootleg copy is highest when it is made immediately after a release. Because of the optical and electronic properties of the screen display and the camera, there is a varying degree of low frequency brightness interference or “Flicker” in the derived pictures. This is due to the random synchronization of the camera's picture rate with that of the screen's display rate. The display rates may also be different in frequency as well as relative phase. The flicker frequency contains components that are differences between the camera and display picture rates, and their harmonics and side-bands. When an NTSC camera points at a movie screen, the fundamental difference in picture frequency will be about six Hz. Differences in picture frequency may also be due to components, such as the field rate of the camera and the double exposure of each movie frame, (60 and 48 Hz respectively), that are of twelve Hz. In Europe, such differences in picture frequency may also be due to other low frequencies whose main components are of one and two Hz. These effects are well known in the literature. Increasing the open time for the camera's shutter, so successive images are blurred together can reduce the flicker. However, this tends to cause judder or jerky pictures subject to movement in the recorded output from the bootleg copy. Home movie cameras often employ automatic gain and aperture values over a period of a few fractions to some seconds so that the task of setting the exposure for the picture is an automatic rather than manual process. However, these adjustment circuits are not normally designed to significantly reduce flicker as they operate with time constants that are too long and are greater than the flicker modulated sum and difference frequency sideband components.

If the flicker is sufficiently large in amplitude, then there is the possibility that the shot change detector will be triggered by the spurious signals even though there is no change of scene. Therefore, false vectors could be logged as scene changes when actually there were none. This is not an inherent problem to one or more embodiments of the present invention. However, this may extend detection times of a clip unnecessarily.

Flicker can be caused by a low frequency signal that is added to the video waveform, thereby varying the picture brightness. Alternatively, it can be caused by modulation of the brightness by multiplying the picture level with the low frequency interference. It is well known in prior art literature that modulation can produce a complex spectrum for the resulting signal components that will apply generally also in this scenario. In general both of the effects will be present simultaneously.

In the former case re-establishment of the correct reference black level in the picture, (with analog signals usually known as “Clamping”), largely reduces flicker to acceptable levels and this process usually occurs automatically in the camera's or following video processing electronics using well known techniques. However in the latter case of modulation causing multi spectral component interference the gain must be varied dynamically throughout successive pictures or even throughout each picture to reduce the flicker level.

One or more embodiments of the present invention, as shown in FIG. 3 incorporating variable gain elements to ensure the mean brightness of every picture is fixed to be the same, can be adapted to accomplish a reduction in the flicker interference. In one embodiment of the present invention, integrators 301 and 305 are replaced by low pass filters whose cutoff frequency is about 20 Hz and the sample, and hold elements 302 and 306 are replaced by the circuitry normally associated with digital (or analog) compander or limiter components that provide a dynamic gain variation during the content part of the picture. Compander or limiter components usually employ short attack and relatively long recovery times that are controlled by the low pass filters in a feed forward or feed back loop, and are well known methods of gain stabilization. Attack and recovery times are chosen to be a balance between not creating too much image distortion and on the other hand sufficient dynamic gain variation to reduce the effect of the flicker. In some embodiments of the present invention, anti-phase gain variation reduces flicker interference in the original signal to values that substantially reduce the possibility of false scene change detection by the system.

One or more embodiments of the present invention uses one variable gain element at the signal input to operate on the entire media signal entering the system. FIG. 4 shows a block illustrating an exemplary flicker reduction system. Variable gain element 400 performs dynamic gain variation using a negative feedback filter having a level reference 402. Negative feed back loop filter 401 incorporates the attack discussed above, recovery time constants, and 20 Hz low pass filter. A system as shown in FIG. 4, reduces flicker and corrects mean brightness. In one embodiment of the present invention, only one picture store one 403 is required. The signal is processed as discussed earlier using subtractor 404, low pass filter 405, DC restore 406, threshold detector 407 with level reference 408.

Trigger output 409 supplies resets to zero at shot changes for 16 bit counter 411 that is fed from picture synchronizing pulses 410. The reset also enables the store to record the maximum count 412 while the vectors are processed in data processor 413. Identifiers are supplied to the file in master database 415 along with the ownership and auxiliary information 414. When a match is obtained after a search, the identity is displayed at display unit 416. In one embodiment of the present invention, counter 411 is a vector counter to include time code.

Embodiments of the present invention improve accuracy of the detection of shot changes or cuts between scenes. A system in accordance with one or more embodiments of the present invention provide shot change detection that are more reliable for picture sources that have been subject to manipulation. One or more embodiments of the present invention reduce probability for false vectors being logged and, therefore, shorter identification time because fewer vectors are measured to obtain a suitably low value for the probability of an error.

One or more embodiments of the present invention is directed to analyzing and improving detection methods in which successive pictures are subject to rapid or fast movement.

But first it is important to understand the operation of the shot change mechanism for relatively stationary scenes in which the camera is steady and there is only small movement by the subjects in the scene. Or the objects in a scene are stationary and the camera moves slowly while making a pan or zoom, or a combination of any or all of these effects. A very common scene is where a shot is stationary but the principal image object is someone talking. Therefore, there are small mouth movements accompanied often by movements of the head and perhaps hands that may also be in the shot. Adjacent pictures will differ very little in this typical scene largely because of the relatively high picture rate, at NTSC television rates for example there is only about 33.37 milli-seconds between pictures, and this time interval is too small to give rise to large changes, therefore adjacent pictures will be very similar to each other. However, subtracting these pictures will produce an output that corresponds to the edges in the components of the object that have changed position. These components will be large in amplitude when the edges of objects in the picture have a large brightness change in the picture content from objects that surround them. At these edges, depending on the picture content, the resulting amplitude of the difference in components may have a high value.

The subtraction process has some similarity to differentiation or high pass filtering of the signal, in that there is an increased gain at high frequencies, relative to the low frequencies that are largely greatly reduced in amplitude by the subtraction process. Furthermore, the components will in general be the result of movement at any angle in the two dimensional image. Thus, horizontal, vertical and other angular components will be obtained. Therefore, the low-pass filter that follows the subtractor is an important component to remove the high frequency edges caused by components that might otherwise trigger the shot change detector. The low pass filter must be a multi-dimensional filter to remove the horizontal, vertical and other angular components of the difference signal. Such filters are well known in the literature and are common in digital signal processing techniques in communications theory and, particularly, in image processing wherein spread spectrum and other communications techniques apply multi-dimensional digital filters. The detailed designs will not be discussed further here since they are so well known in the literature, but one aspect of their properties will be pointed out that is important for this invention.

As the movement of an object or parts of an object in the image increases in speed the difference between successive pictures caused by the motion will contain more pixels. In other words, the frequency of the difference components is reduced. The optimum choice of cutoff frequency for the low-pass filter depends on how much inter-picture movement is to be allowed to pass through the filter.

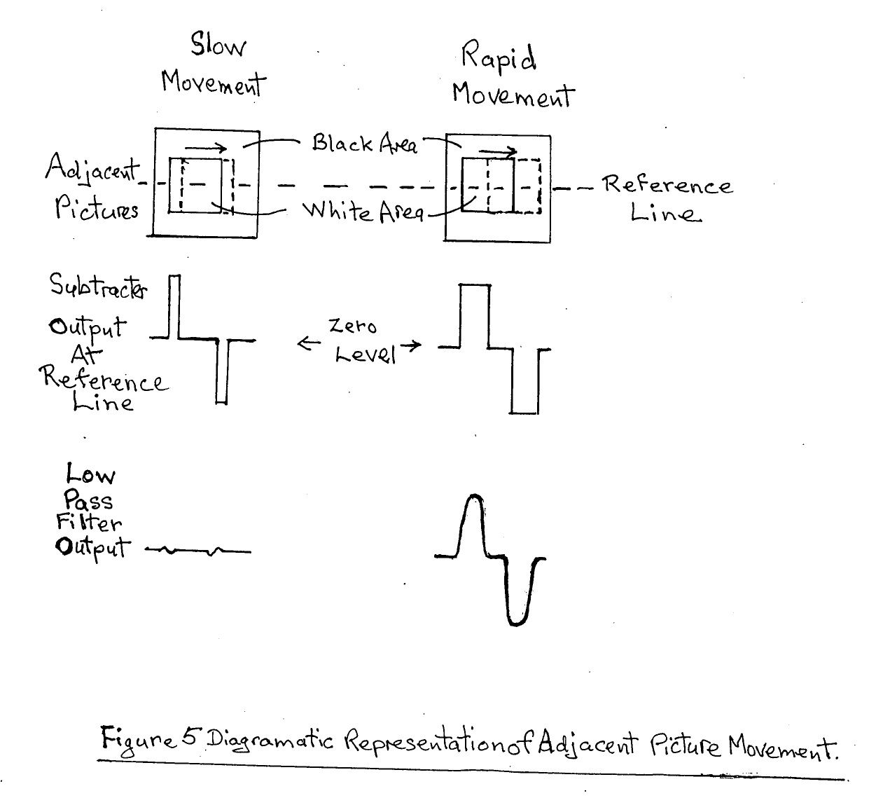

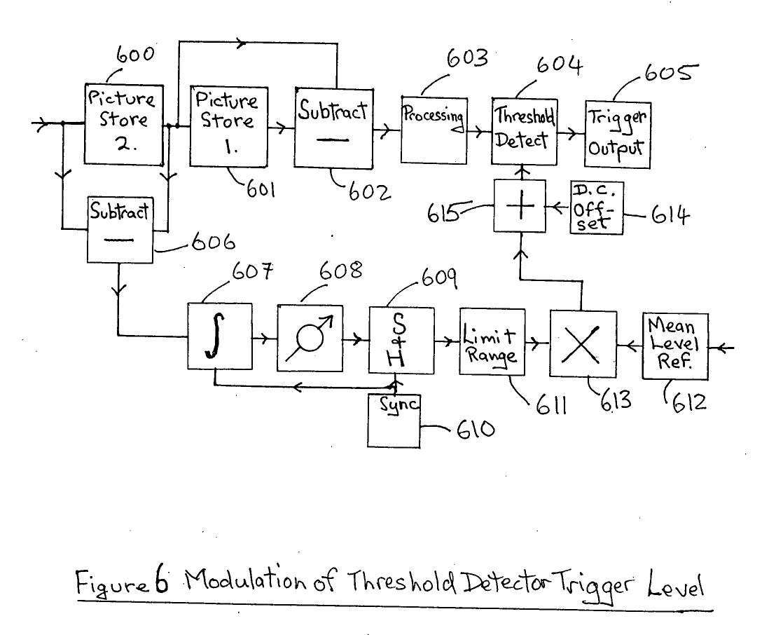

FIG. 5 illustrates a diagrammatic representation of adjacent pictures that are subject to small and then rapid movement, for example, in the horizontal direction. Effect of the low pass filter on the resulting subtracted picture signals is also shown in FIG. 5.

The maximum number of pixels to make up a television picture is dependent on the number of scan lines for a vertical value and the high frequency bandwidth of the system for horizontal values. In film-based systems, number of pixels is the minimum size of the color dyes as a ratio of the height and width of the frame. In electronic images, the maximum possible number of pixels is determined by the maximum frequency that is transmitted which is a value that is a little less than half the Nyquist sampling frequency. For composite video, such as NTSC and PAL systems, the Nyquist sampling frequency was originally three times the color subcarrier frequency or about 10.7 MHz and 13.3 MHz respectively. The International standard that has created a common specification for the sampling frequency is known as ITU-R or BT.601 and was formally CCIR 601. The sampling frequency is 13.5 MHz for Luma signals and 6.75 MHz for Chroma. (4:2:2). The corresponding sampling rates for HDTV, BT.709-4 are 74.25 MHz and 37.125 MHz respectively.

However, there are also a plethora of standards to include 4:3 and 16:9 displays for NTSC/PAL/SECAM in addition to the HDTV standards of 1280 pixels in 720 line interlaced or progressive displays and 1920 pixels in 1080 interlaced or progressive displays. Yet others may involve sub-band, or down sampling rates such as those often used by very low bit-rate encoders and decoders.

It is not the purpose of this invention to discuss the relative merits of the various standards but rather to indicate sensible values for the cutoff frequency of the low-pass filter following the main subtractor. By specifying the cutoff frequency in terms of pixels it is possible to take advantage of scaling of the filter in step with the pixel size and sampling rate of the various TV standards for the following reasons.

In a generic digital filter design a series of delays are used that are equal to an integer or fractional value of the reciprocal of the sample rate. In other words, they are a ratio of or equal to the time for each sample or integer multiples of each sample. The output from the filter is derived by multiplying successive samples from the delays by specified coefficients and then algebraically summing the values so obtained. The frequency characteristic of the filter scales with the applied sample rate. Digital filters are often designed by specifying the minus 3 dB point in the frequency response, the pass-band ripple, the stop-band frequency characteristic and the stop-band ripple. As discussed earlier, it is important for embodiments of the present invention that the processing is as simple as possible so that the system can operate at many times real-time on the program. Therefore, the filter must be designed with this factor accounted for in the design. Multi-stage filters have many coefficients to calculate and provide steep roll-offs in the frequency characteristic for the stop-band. Because such filters require more processing than is generally needed for this application, fewer stages and coefficients with less steep roll-off filters would suffice. This strategy eases the computational load and calculations can be performed at a faster rate. Therefore a gentler roll off, while not essential, is preferred. To achieve sufficient stop band attenuation, the minus 3 db point for the filter will be lower in frequency than if a high computation steep roll-off filter is used. An important aspect of the filter design for this invention, indeed for video signals in general, is that it should be non-dispersive, that is it should have a constant group delay as a function of frequency. Otherwise, the video waveforms will be distorted and could interfere with the optimal operation of the threshold detector.

In one property of digital filters, minus 3 dB frequency characteristic of the filter is directly proportional to the Nyquist sample rate. Since the number of horizontal pixels also scales and is approximately proportional to the sample rate, it is quite useful to consider the filter in terms of pixels to take advantage of this normal relationship.

In alternate embodiments of the present invention, the process of subtraction of the pictures and/or group of pictures together with low-pass filtering can be accomplished by stochastic and/or sub-Nyquist sampling of the signals or other well-known methods. Furthermore, such methods may be more economical with respect to the number of required processes (or lines of software code) and, therefore, be able to run faster in a given micro-processor.

In one embodiment of the present invention, if small movements that need to be removed by the filter are about one or two percent of a picture width and height, it would be reasonable to set the low-pass filter's minus 3 dB point to about three percent of the image's total horizontal and vertical pixels. In another embodiment of the present invention, it would be reasonable to set the low-pass filter's minus 3 dB point to about five percent of the image's total horizontal and vertical pixels. Embodiments of the present inventions, implemented in other or special applications, can optionally use any appropriate values for these parameters. This is particularly important when the requirement for minimal processing and high speed is required. A slow roll-off filter uses fewer stages and a smaller number of multiplier coefficients to be calculated than a steep roll-off filter. Since the rest of the system in one or more embodiments of the present invention consists of delays, a subtracter, gain elements, counters, integrators and similar simple elements with simple software, the low pass filter may demand the most computation in the system. Therefore, it is very important to design a simple filter that nevertheless reduces difference outputs to an acceptably low level to avoid false shot change detection. A relatively gradual roll off is optimum, that has a characteristic with some ripple in the pass-band and be many percent of pixels as it reaches its minus 3 dB point and ultimately gives about 50 to about 70 dB attenuation in the stop band or any other suitable figure considered by the developer.

Another important function for the filter is to remove high frequency difference components produced by sub-titles or other multi-lingual, alphabet or number characters in the display. When they are stationary in adjacent pictures, the subtractor will remove them, but when they change because of high contrast, they could trigger the threshold detector and indicate a shot change when there was none. This does not include those that could be caused by the inserted characters themselves. Since sub-titles may be in different languages for the same movie, the characters will vary both in content and timing according to the edition being analyzed. False vectors that differ not only from the visual content but also another language version of the same work could be logged. Therefore, the low pass filter must remove the high frequency components that originate from this interference with the subject pictures of the visual content. Fortunately, characters invariably generate edges that are normally only a few pixels wide. Frequencies that they originate will be filtered out and removed from the difference signal to avoid false vector detection. For this reason, the filters minus 3 dB point might require to be set to the equivalent of more than 5% of the pixels per horizontal and vertical lines to take account of this possible source of error. Also, some captions can be quite prominent, therefore larger in size than normal sub-titles and these will have to be removed as well, increasing the need to filter more than 5% of the pixel width.

Table 1 provides exemplary parameters of the number of horizontal and vertical pixels that comprise a display. Table 1 also shows values for a range of 3 to 5 percent of the horizontal and vertical pixels, which are suggested as a minus 3 dB point for the low pass filter. Exemplary numbers for HDTV, NTSC and PAL are also shown.

TABLE 1

| | Horizontal | Horizontal | Vertical Pixels | Vertical |
|---|---|---|---|---|
| Source System | Pixels | 3-5% | (Lines) | 3-5% |
| HDTV p | 1280 | 38-64 | 720 | 22-36 |
| HDTV i | 1920 | 58-96 | 1080 | 32-54 |
| NTSC 4:3 | 640 | 19-32 | 480 | 14-24 |
| NTSC 16:9 | 704 | 21-35 | 480 | 14-24 |
| PAL 4:3 | 768 | 23-38 | 576 | 17-29 |
| PAL 16:9 | 1024 | 31-51 | 576 | 17-29 |

As previously discussed, one or more embodiments of the present invention has a premise that successive pictures are, or are very nearly, the same during a given scene and that when the scene changes the picture after the cut is different from that before the cut. However there are scenes in which the content is changing substantially without an actual shot change. This occurs when there is rapid movement of the scene contents. Rapid and fast movement can arise due to at least four categories of scene content, each of which gives significant differences between successive pictures. They are as follows:

First, a scene in which the camera is fixed, and the objects in the scene are moving rapidly within, across, or in and out of the picture.

Second, a scene in which the camera is panned, moved rapidly sideways or up and down, or both making a rapid change to the position of the objects in the scene and introducing new objects to the scene.

Third, the camera lens produces a fast zoom, or change in focal length, that maybe towards or away from objects in the scene.

Fourth, a fast “wipe” or cross-fade is performed, that is, rather than a cut between scenes; a rapid scene change is performed in which parts of a picture are cut out by moving edges, as the next picture is cut in at the edge. Wipes are made using a wide variety of shapes for the picture scene change, from a simple sweeping line to complex geometric shapes according to the director's creative process, in vertical, diagonal and/or horizontal dimensions of the screen.

In practice, some or all of these processes may be happening simultaneously. For example, a rapid pan to follow a person running, may be accompanied by a zoom so that a closer picture of the person is obtained. These effects are familiar to the general public as they occur regularly in movies, television programs and other motional media programs.

There are other types of large adjacent picture differences that can trigger the shot change detector that are not directly associated with rapid movement. These are situations in which a large brightness change occurs for just one, two or very few frames, even when there is no change of scene. Short lived large brightness changes can be caused by an explosion or the flash from a gun, or a flash unit from a camera, or lightning or other commonly found cause. A shot change detector will be triggered in many of these scenarios if the brightness impulse is of sufficient amplitude. Thus, vector counts of one or a succession of a few ones or other small numbers will be detected.

If the content changes sufficiently between successive pictures, during the rapid movement processes, then the output from the difference picture subtractor will have a sufficiently large low frequency component. This frequency component is passed through the low pass filter and trigger the threshold detector to produce a counter reset and a vector count of one, or time equivalent of one picture. During fast movement, successive pictures will be sufficiently different to produce a succession of vectors of value one. The database would therefore have a succession of ones entered as the identity vectors during these events.

FIG. 5 illustrates an exemplary difference between slow and rapid movement in adjacent pictures. For ease of illustration, the pictures are very simplified and somewhat exaggerated. The picture consists of a black level screen with a smaller white square placed approximately to the left of the middle and is delineated by a full line. The next adjacent picture is drawn on the same screen with the white square delineated by a broken line overlapping that in the first picture. The white square has moved to the right by a small amount for the slow movement column and a large amount in the rapid movement column. The illustration represents the difference in adjacent pictures for a typical scene that has on the one hand slow movement in which the differences between adjacent pictures are small and fast movement in which those differences are large. The movement shown is in the horizontal direction, in practice there will be vertical or diagonal, or combined movements in general as well.

By inspection of a reference line in the frame, the result of subtraction of the two pictures is shown on the next row in FIG. 5, as a typical picture subtractor output. Subtracting second picture from the first is the same as changing its sign and adding. Therefore, overlapped portion of the white square is reduced to zero level, and white square to the left of the picture is shown as a positive pulse and white square on the right side as a negative pulse. The pulses generated by slow movement are narrow and have significant high frequency components; while, pulses generated by fast movement are broader and have significantly lower frequency content. Both sets of pulses are then low pass filtered and, as shown in FIG. 5, most of the narrow pulse energy is removed by the filter whereas significant energy from the broad pulses passes through the filter. Thus, in the case of rapid movement, threshold detector would be triggered and register a shot change when technically there was none.

Such events do not detract from the fundamental way embodiments of the present invention operates. This is because the succession of unity vectors will both vary in number according to the duration and amount of the rapid movement, and be placed with different sequences of scene changes either side of these events. In fact, they would add to the uniqueness of a given program's identity because no two motional media will be exactly the same.

One or more embodiments of the present invention easily handle rapidly changing signals, especially for excerpts that maybe very distorted compared to the original database copy. Although more shot changes detected reduces the overall detection time for a clip at a given probability, these “false” shot change detections due to rapid movement would appear to be an advantage to reduce clip identity times. One or more embodiments of the present invention ensure minimal false vector detection when heavily distorted excerpts are to be analyzed.

There are scenarios in which improved robustness to rapid movement effects would improve the confidence level of identification. They are as follows:

First, pictures that have been reduced in size by means of a crop of the sides or top and bottom or both could cause some rapidly moving objects to be removed from the source under analysis, and therefore fail to trigger the threshold detector.

Second, for pictures that have been re-scanned, for example, by pointing a camera at a display, there may be integration of movement effects between successive pictures. This is because the re-scanned output may have pictures that are partial sums of successive pictures in the original. The integration of movement effects will depend on the persistence and exposure time of the original display and the shutter time and electronic persistence of the image in the camera. The integration of movement effects will also depend on the phase of the pictures displayed relative to the pictures recorded by the camera as in general these will not be synchronized, and such phase may vary as a function of time.

Third, re-scanned pictures may include some low-frequency interference or “Flicker” depending again on the factors discussed in the second scenario. Such effects can also affect triggering of the level detector to change the one count sequence to include other numbers such as a two or three as well as one etc. Even if systems to reduce flicker are in place, there may be still some residual flicker induced component in the signal that can cause an uncertainty in detection with media from differing sources.

Fourth, in cases where the movement is only rapid enough to produce successive ones from the master database reference, or another source such as a low quality movie print played from a telecine machine, may produced blurred or other effects such as side to side wobble of the pictures. Such effects give successive pictures that are just below the threshold, and do not produce a rapid succession of vector counts of one. A reverse of this situation could also be true when the master is just above the detection threshold. This does not record single count vectors but the unknown media does.

A threshold of fast movement effects can arise that are just below or just above the detection threshold required to successively trigger the shot change detection technology. While erroneous counts do not affect the overall ability of a system in accordance with one or more embodiments of the present invention to correctly identify media, as explained both in this application and the co-pending applications, without an improvement to robustness, the time required to effect identification will be increased. This is because of the need to log more vectors before a definitive identification is obtained. It is important to ascertain identities in the shortest practical time.

One or more embodiments of the present invention create three basic strategies to improve the robustness in the above scenarios.

One embodiment of the present invention modulates trigger level in a threshold detector when rapid movement is detected so as to reduce the detector's sensitivity. Another embodiment of the present invention varies the cutoff frequency (−3 dB point) with an adaptive low pass filter following the main subtractor. Yet another embodiment of the present invention separately accumulates the vector numbers supplied to and logged in the database by preprocessing the vectors so obtained. These systems can be used together in an embodiment of the invention.

In embodiments of the present invention that modulates trigger level, threshold level is increased in the detector when rapid movement is detected so that differences that are obtained from the subtractor must be of increased amplitude to trigger that threshold. Thus, if the threshold level is increased, picture movement would not be sufficient to trigger the threshold. If amount of the increase is without limit, normal cuts will not be detected. It is important that the movement detector positively modulates base threshold level produced by the mean brightness of the pictures, as described earlier. The level is modified by an attenuator and a multiplier, rather than an adder function. In some embodiments of the present invention, an adder could be used. In another embodiment of the present invention, for speed and simplicity, the multiplier does not have to be a low distortion signal version for this purpose, but rather a multiplier that gives an approximate multiplication. Exemplary multipliers include types in the digital domain that employ the shift and add method, or a look up table well known in digital signal processing techniques.

In one embodiment of the present invention, a modulator must have its range restricted to a reasonable maximum value. Else, the trigger level could be increase to the point where the main subtracter fails to detect normal scene changes which occur while there is also rapid movement. In another embodiment of the present invention, detection of shot changes is performed with a reasonable margin in which modulation of the trigger level is about 10%. Such modulation of the trigger will not significantly reduce the detection of shot changes. In yet another embodiment of the present invention, aside from the limit on the amplitude of the trigger level modulation, an attenuator can be used in the path of the signal to the modulator to reduce the sensitivity of the system to fast movement and maintain the overall sensitivity to detect shot changes. In yet another embodiments of the present invention, modulation of the trigger level is from about 1% to 100%. In other embodiments of the present invention, modulation of the trigger level is a variable whose value is set according to the genre or type of media that is to be identified.

A genre can be broadly identified in a very simple way by counting the number of shot changes as a ratio of the total pictures in the work under review. With frequent shot changes, the percentage of cuts will be higher, for example, in music videos and advertisements than in period plays. Methods in accordance with one or more embodiments of the present invention could be further refined to ascertain the number of fast movement sequences in the work and relate to the genre of action movies. Exemplary methods like these can be incorporated as general statistics in the database as a file header and thereby general classifications of content can be established.

In one embodiment of the present invention, content classification information can be used to set the gain parameter for the detection of fast movement, if the genre but not the identity is known.

In one embodiment of the present invention, the threshold level is increased by 10% for a signal increase of 10%. Thus, the voltage would be multiplied by 1.1. In one embodiment of the present invention, if the mean brightness corresponds to detector level of 120 milli-volts, then threshold level should be modulated to be 132 milli-volts. In another embodiment of the present invention, the mean brightness corresponds to detector level of 300 milli-volts then threshold level should be modulated to be 330 milli-volts. In embodiments of the present invention where the multiplier is a simple design and produces an approximate values, such as 1.09 or 1.11 times as the multiplicand rather than the wanted 1.10, modulations can still be achieved.

To determine the limit of the modulation, it is useful to consider the effect of movement effects at various speeds—from stationary to very fast. In one embodiment of the present invention, the percentage change of the content of successive pictures can be considered.

For example, consider the effect of a 5:1 zoom into the center of the scene with the camera held steady. When the zoom operates, center 4% of the picture will be successively magnified until it fills the whole of the screen at the end of the zoom. About 96% of the original picture will fall outside the final picture. If this is a slow constant rate zoom, about three seconds, then at the normal movie picture rate the zoom will occur for three times 24 pictures or for 72 pictures. Therefore, a somewhat simple way of looking at this effect is to say that there is about a 96 divided by 72 percent, or 1.33%, change in the content of each successive picture. On the other hand, if the zoom was very rapid and, for example takes one third of a second, there would be about a 12% change in the content of each successive picture. Although, to the naked eye, the content would change by this amount, objects near the edge of the picture will move outside the display and only the center of the image will remain constant and intermediately placed objects will increase in size. From the electronic point of view, all the content will be changing except at the exact center of the picture and the movement of objects will be more rapid towards the picture edges. Therefore, the difference between successive pictures obtained by electronic subtraction will contain components that lie below the low pass filter's cut off frequency and will be greater in amplitude than the 12% indicated above. As successively faster movement is presented to the low pass filter following the subtractor, they will decrease in frequency and eventually be below the cut off frequency of the filter, and thereby pass to the threshold detector. Also, rapid movement appears blurred to the naked eye and tends to be blurred electronically. Blurring has a similar effect to the reduction in the high frequency components or a reduced sharpness of the pictures in both the vertical and horizontal components. One or more embodiments of the present invention can be applied to other types of fast movement delineated above, even though the exact visual and electronic consequences differ in each case.

Therefore, limits to the modulation of the threshold level is an arbitrary decision, and is based on practical values that balance the ability of the system, in accordance with one or more embodiments of the present invention, to detect cuts between scenes and not detect some of those generated by rapid movement. At the same time, it is to increase the robustness of the system, in accordance with one or more embodiments of the present invention, to different types of source of the same original content.

In one aspect of the present invention, to be able to modulate the trigger level in the threshold detector, it is necessary to detect and to derive a value for the amount and speed of the movement. There exists very sophisticated ways to ascertain movement in video in the MPEG-4 and H.264/AVC technologies in which motion predictor frames are produced for groups of pictures (GOP). These techniques could certainly be adapted to provide the necessary input to the modulator of the threshold trigger level.

One aspect of one or more embodiments of the present invention is that the processing is relatively simple so that the identification system can operate at many times real time in speed. The MPEG-4 and H.264/AVC methods require very significant processing to decode the video or the components thereof and are not able to run at many times real time.

Embodiments of the present invention provide a simple method that is both economic in processing and the number of components. One or more embodiments of the present invention uses the aforesaid second of picture store that is also the means for deriving the average level of two successive pictures. Input to this store also supplies the input to a second subtractor, and the output of this store supplies the other input to the subtractor. The output of the subtractor is integrated so that an average of the difference for a whole pair of adjacent pictures is obtained. In this respect, its operation is different from that of the main shot change detector, whose output is only low-pass filtered to remove difference components of the signal caused by small movements. Irrespective of the size of the input, the output from the integrator is adjusted for gain and has a limit placed so that a specific maximum value is obtained. This signal is sampled and held and passed to the modulator, where it multiplies the trigger voltage by a factor that depends on the fast movement detector. Detector trigger level is raised when fast movement is present and, therefore, the overall system will not log vectors for medium speed movement. Thus, one or more embodiments of the present invention achieves in a very simple way the objective discussed above, at the same time uses few extra components, and most importantly does not limit the speed of operation of the overall system as the processing involved is simple.

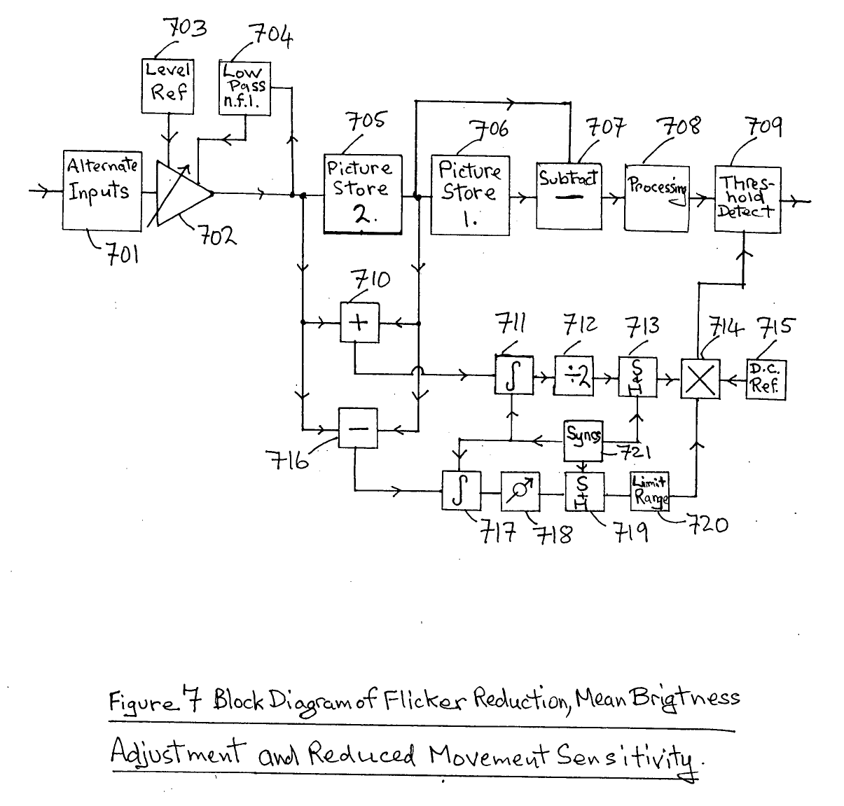

FIG. 6 shows a block diagram illustrating an exemplary system for modulation of threshold detector trigger level. A second picture store 600 is placed in series with the main first picture store 601. Input signal to second picture store 600 is also an input to subtractor 606. Another input to subtractor 606 is the output from second store 600. When there is rapid movement in adjacent pictures the output from subtractor 606 will be a large value. Integrator 607 integrates this large value for the duration of one picture and accumulates the average level of the subtracted signal. This mean level signal is attenuated at attenuator 608 and then sampled and held by component 609. Picture synchronizing pulses from sync 610 serve to reset integrator 607 to zero after each picture and before re-integrating next picture's output, and to operate the sample and hold device 609 for the duration of each successive picture. Amplitude of this accumulated difference signal is limited in range by range limiter 611. When subtracter 606 has a large signal output, attenuator 608 and range limiter 611 reduce the signal to a percentage of the mean brightness of input pictures.

Meanwhile, one or more embodiments of the present invention implements a mechanism for a look ahead at the incoming signals. One or more embodiments of the present invention passes the pictures to main picture store one 601, subtractor 602, signal processing unit 603, and threshold detector 604. As discussed above, processing unit 603 processes the signal to remove high frequency components and then DC restore the derived output. Processed signal from processing unit 603 is provided as one input to threshold detector 604 for generating threshold detector's trigger level.

Output signal from range limiter 611, representing a detection of rapid movement or flash-lit frames, is used in multiplier 613 to modulate or multiply the mean level of reference brightness signal 612 derived using exemplary methods shown in FIGS. 1 and 2. The modulated signal output is supplied to the adder 615 in addition to a second input it receives from the DC offset 614. The combined signal is sent to threshold detector 604 to establish a trigger level in the detector. Thus, when threshold trigger level is raised by a modulated value in a system in accordance with one or more embodiments of the present invention raises, the system would have less sensitivity toward rapid movement in the incoming media source.

One or more embodiments of the present invention combines systems for flicker reduction, mean brightness adjustment and reduced movement sensitivity to reduce effect of flicker, adjusting the threshold for the summed mean brightness of adjacent pictures, incorporate DC offsets to reduce the effects of noise on low brightness pictures, and reduce the impact of rapid inter-picture movement. FIG. 7 shows a block diagram illustrating an exemplary system for flicker reduction, mean brightness adjustment and reduced movement sensitivity. The exemplary system according to FIG. 7 reduces effect of flicker, adjusts the threshold for the summed mean brightness of adjacent pictures, incorporates the DC offset to reduce the effects of noise on low brightness pictures, and reduces the impact of rapid inter-picture movement. Input signal can be from different sources 701. Exemplary sources include disc, the Internet, wireless, computer, and the like. Input signal from source 701 is passed to variable gain element 702. As discussed earlier, gain element 702 adjusts the pictures for mean brightness and reduces flicker with feed back filters 704 and level reference 703. Picture store 705 supplies pictures to adder 710, subtracter 716, picture store one 706, and main subtractor 707. Output from adder 710 is first sent to integrator 711 and then to divider 712 where it divides the signal by two. Divided signal from divider 712 is sampled and held in device 713. The output from subtracter 716 is forwarded to integrator 717, attenuator 718 and sample and hold unit 719. Picture syncs from sync 721 are used to reset or set integrators 711 and 717, and sample and hold units 713 and 719 respectively. Mean brightness amplitude of output from sample and hold unit 713 is sent to modulator 714 where it is modulated by output from range limiter 720. DC level reference 715 provides reference inputs to modulator 714 and the net signal from modulator 714 is used to dynamically adjust trigger levels in threshold detector 709. Further, output from main subtracter 707 supplies difference signals to processing unit 708, which in turn provides processed signals to threshold detector 709.

Another method for reducing the sensitivity to rapid inter picture movement of a system, in accordance with one or more embodiment of the present invention, is to attenuate the difference frequency components produced by the subtractor. As explained earlier, as rapidity of movement increases, differences between each adjacent picture become larger and frequencies of components in the subtracted signal decreases. If the cut off frequency of the low pass filter following the subtractor is reduced, these components of the signal can be attenuated sufficiently in amplitude to prevent operation of the threshold detector. Furthermore, the cutoff frequency of the filter can be made to vary and operate adaptively according to the rapidity of the movement in the scenes. In this way, the sensitivity of the system can be optimized both for scene change detection and robustness to rapid movement. In a normal viewed media, this technology would not be acceptable because the resulting pictures would have variable and unacceptably low definition. One purpose of one or more embodiments of the present invention is to robustly detect shot changes without movement generating spurious information that may defeat the detector's accuracy at shot detection.

In one or more embodiments of the present invention, in addition to the threshold detector sensitivity reduction, output of the look-ahead signal can be used to vary the low pass filter's cut-off frequency by use of an adaptive filter. More particularly, if the filter is implemented by the use of look up tables for the coefficients, there can be several tables of multipliers that give various scaled amplitude characteristics for the filter. As the output from the look-ahead subtractor to integrator increases, successive look up tables or equivalent are used to lower the cutoff frequency of the filter. Thus, an increase in the rapidity of the movement is arranged to produce a lower frequency characteristic for the filter.

To minimize computational load, for example, a filter with a modest roll off rate of 36 dB per octave is used. It is useful to estimate the number of delay elements and coefficients that would be required. A filter not of broadcast quality can be less restrictive because of its in and stop band ripple tolerances. However, for repeatability, it is suggested that a standard may be chosen so that all analysis software would react in a similar way to all signal sources. For example, in-band ripple is taken as plus or minus 0.025 db or +/−1.003 and the stop band ripple as −60 db or 0.001. For a constant group delay FIR filter, whose pass band is 500 kHz and stop band is 1.5 MHz, we can estimate the number of taps or stages from:

$${N}_{e} = \frac{{ω}_{s}}{Δ ω} \cdot \frac{2}{3} {log}_{10} ( \frac{1}{10 {δ}_{p} {δ}_{s}} )$$

Where Nₑ is the number of taps or multiplier coefficients.

$$\frac{{ω}_{s}}{Δ ω}$$

is the ratio of the edge of the stop band frequency to the frequency of the transition band-width that are 1,500 kHz and 1,000 kHz respectively.

δₚ is one half of the peak to peak amplitude of the pass band ripple in the frequency response, 0.003 and

δₛ is the maximum value of the stop band ripple, 0.001.

Inserting the exemplary values gives:

$$\begin{matrix}{N}_{e} = \frac{1 , 500}{1 , 500 - 500} \cdot \frac{2}{3} {log}_{10} ( \frac{1}{10 \times 0.003 \times 0.001} ) \\ = \frac{3 , 000}{3 , 000} {log}_{10} ( 33 , 333 ) \\ = 4.53\end{matrix}$$

This shows that five taps (rounding up) are estimated to be sufficient for the design of this simple FIR filter. It can be seen that it has less than one quarter of the computational load compared to a typical CCIR studio quality FIR filter that has from 21 to 25 taps.

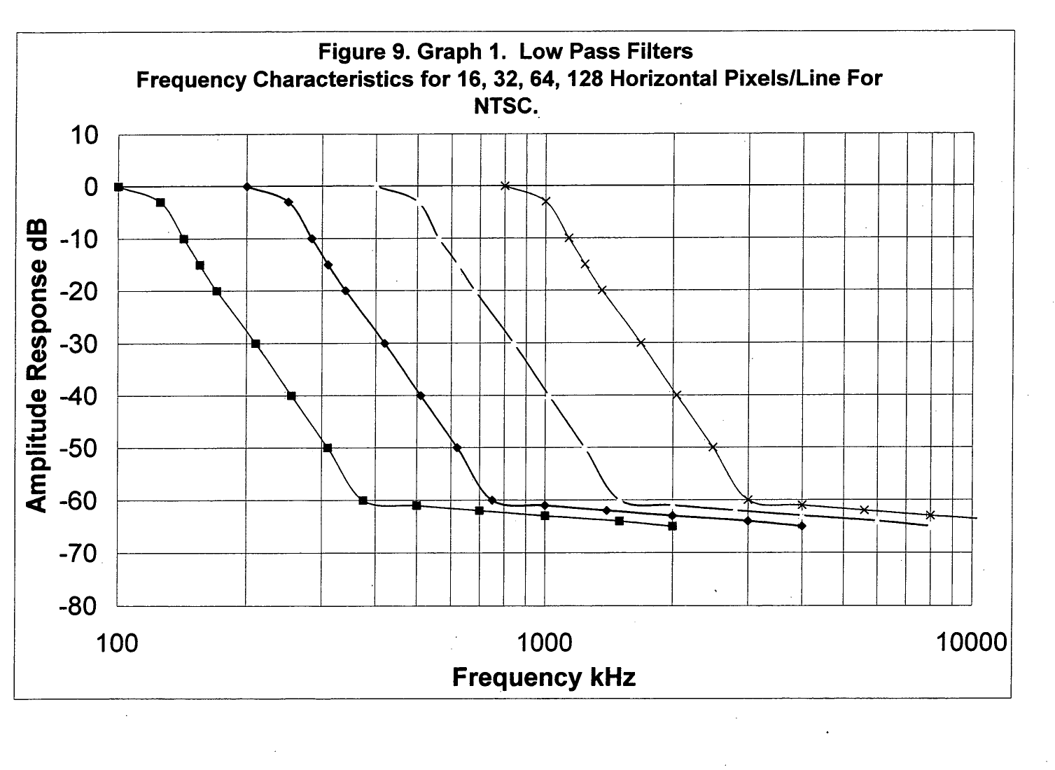

FIG. 9 is a graphical illustration of four exemplary horizontal component filters in which the −3 dB points are nominally set an octave apart at 125, 250, 500 and 1000 kHz. For NTSC 4:3 and 16:9 television, the −3 dB points correspond to about 16, 32, 64, and 128 horizontal pixels per line respectively. Although the number pixels/line starts at a low value, the rate of roll off for these example filters is a modest 36 dB per octave, and significant attenuation does not occur until the frequency and the pixels/line have about doubled. The vertical filter follows this with similar frequency, characteristics for those that are applicable in the vertical domain.

Perhaps a better understanding of the action of these filters is indicated by the following scenario: Suppose two adjacent analog pictures have fast movement in their content and are of mid average brightness and have parts of the picture at black level and other parts at peak white or 700 milli-volts. The threshold detector level will be set to 350 mV plus the small DC offset, and on subtraction the two pictures produce a signal that is 1,400 mV peak-to-peak that is then DC restored. If these difference components were produced by rapid motion, then the 500 kHz filter (−3 dB) will attenuate the signal to 350 mV p-p the threshold level, at −12 dB or at 580 kHz. This corresponds to about 74 horizontal pixels along a line. Attenuated to a level of 35 mV p-p or −32 dB, just 10% of the threshold trigger level, the frequency is about 870 kHz or about 110 pixels/line. A normal NTSC picture has 640 and 704 pixels/line for 4:3 and 16:9 respectively.

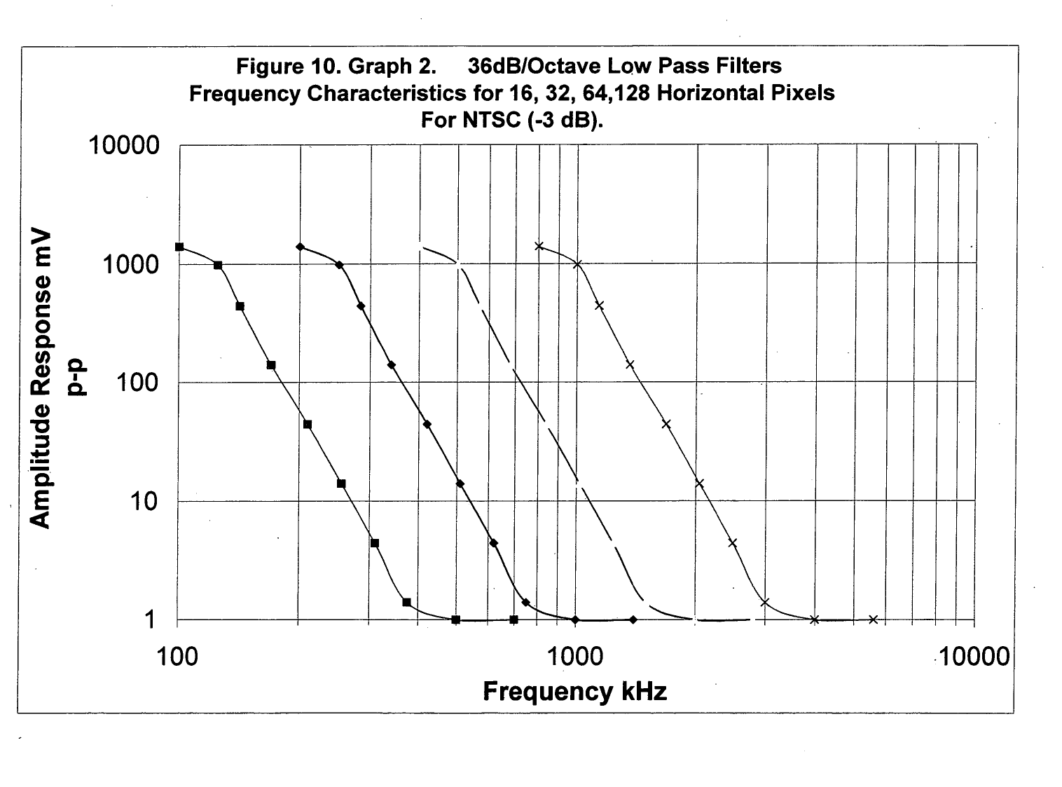

FIG. 10 is a graphical illustration of the same four filters shown in FIG. 9, where the vertical axis plotted in milli-volts p-p on a logarithmic scale. The value of 1,400 milli-volts p-p is taken as the reference maximum value for the input signal.

It is not expected that all these filters would normally be used in an adaptive filtering system, or even that these particular frequencies or roll-off rates are chosen. One intention is to serve the purpose to illustrate the possibilities and a sensible range of possible designs while maintaining overall simplicity. Although the signals and system functions have been described with analog functions, one or more embodiments of the present invention can be implemented with digital equivalents.

Another method for treating the effect of rapid movement involves processing measured vectors before they are logged in the database rather than by the two different signal processing methods discussed above.

In one or more embodiments of the present invention, substantially identical results can be obtained using picture count components of vectors or time code components of vectors.

It would be possible to completely ignore vector counts of one, two, and three and so on by allowing the counter to reset normally when triggered at each fast moving scene sequence, discarding these pre-chosen values, and not logging them into the database. All vector numbers below a chosen value are ignored and only those numbers equal to or above this value are inserted into the database and are logged as normal. A method in accordance with one or more embodiments of the present invention can be used with fast movement scenes that produce counts of low numbers from one up to below the chosen value, and not produce ambiguous counts for different sources, during shot change detection.

However, such an approach has the disadvantage that the total picture count for the program, movie or advertisement will be in error since there would be an indeterminate number of dropped picture counts in the total for the work. The total number of pictures in a given program is a useful parameter in that it is directly related to the total time for the program and can assist in the discovery should pictures have been removed or added to the original content. It is particularly important in advertisements for example, where fast movement, wipes and frequent rapid shot changes are typical of much of this type of content. It is of great importance that the advertiser has knowledge that the whole of the advertisement was transmitted, since advertising is expensive, and incomplete or even non-transmittal of the advertisement is a waste of budget.

Although discarding very low vector counts serves the purpose of one or more embodiments of the present invention, to reduce the possibility of errors caused by rapid movement from alternate sources of the same media, a preferred system for accomplishing this is described below.

Another embodiment of the present invention provides a system that uses a second counter to count pictures fed from picture synchronizing pulses. However, these picture pulses are prevented from operating the second counter whenever the number is above the pre-determined value, for example a value three. In this way, the second counter will only operate and count pictures when the main counter has counts of one, two or three before reset. When the first counter is reset to zero with these low values, the reset to the second counter is blocked and the second counter is not reset to zero. None of these counts are logged in the database, but are in temporary storage in the second counter or other storage means for later processing. As long as the sequence of low counts occurs in counter one, counter two continues to count and accumulate the total number of pictures that give rise to a succession of low counts, for example, of three and below. When counter one derives a count that is four or more, the current accumulated count of counter two is added to that number at the next reset and the value is then passed to the database and logged. Counter two is then reset to zero and its output remains unused until values of less than four are obtained again by counter one. Thus, a total number of pictures can be correctly recorded and logged. This is because the first vector in the database, after a sequence of low count events, contains a value that includes all the pictures that were not logged and would otherwise be missing in this sequence.

A more complete understanding of the present invention can be obtained by referring to the following illustrative example of the practice of the invention, which examples are not intended, however, to be unduly limitative of the invention.

### EXAMPLE 1

In the following example illustrating the above methodology, consider afast movement in a movie content that produces a sequence of twelve “ones” from the shot change detector. This movement occurs for a period of exactly one half of a second, and each adjacent picture is detected as a shot change. Consider an immediately previous vector of 123, and a immediately following vector of 53. In practice these will have any value according to the content. Normally the picture sync pulse separator is not affected by the content so the total count of vectors during the period will always be the same. So the actual count by counter one will be:

123, 1, 1, 1, 1, 1, 1, 1, 1, 1, 1, 1, 1, 53 . . .

For the reasons discussed earlier, consider a second source of the same movie produces a sequence of vectors during this period that are as follows:

123, 1, 2, 2, 3, 1, 3, 53 . . .

All the counts that are 3 or less are not logged, but the second counter is actuated for numbers that are 3 or less and accumulates these numbers by adding each together. Total count by the second counter will be 12 in both of these examples. This total count could be logged as twelve, so the sequence of numbers stored in the database could be:

123, 12, 53 . . . in this example.

In a preferred method, in accordance with one or more embodiment of the present invention, accumulated value is added by the second counter to the next count that is higher than 3, that is when the main first counter has counted a number that is equal to 4 or more.

In the above example the database would simply record the following:

123, 65 . . .

The total picture count through the fast shot change sequence is a correct total count of the pictures during this event. This will be correct for the whole movie, irrespective of the source being the original master or a somewhat reduced quality version of the same.

Accumulated value is added by the second counter to the immediate next vector because accumulated count by counter two has a single measured preceded low value of 4 or more instead of three or less followed by larger counts. The isolated low count may be produced, for example, by a flash in a frame. The point of the technique is to avoid logging these low values in the database in case of errors from different sources, so to overcome the problem this single low count must either be discarded or added to the immediately following larger vector. In some embodiments of the present invention, the latter option is preferred due to reasons discussed above. Examples using the same numbers for the immediately previous and following vectors in the sequence are shown below:

123, 1, 53 would be logged as 123, 54.

123, 2, 53 would be logged as 123, 55.

123, 3, 53 would be logged as 123, 56.

123, 1, 2, 53 would be logged as 123, 56.

123, 3, 1, 53 would be logged as 123, 57

123, 2, 1, 3, 53 would be logged as 123, 59

123, 1, 3, 1, 1, 53 would be logged as 123, 59

123, 1, 1, 1, 2, 1, 3, 53 would be logged as 123, 62 . . . and so on.

One or more embodiments of the present invention using these techniques relax the requirement to increase robustness for the detection of fast movement for any of the four main reasons given earlier, including the flash-lit frame phenomenon. An optimum system, in accordance with one or more embodiments of the present invention, can incorporate both techniques to reduce the system's sensitivity to pictures of rapid movement that are on the threshold of being detected or not.

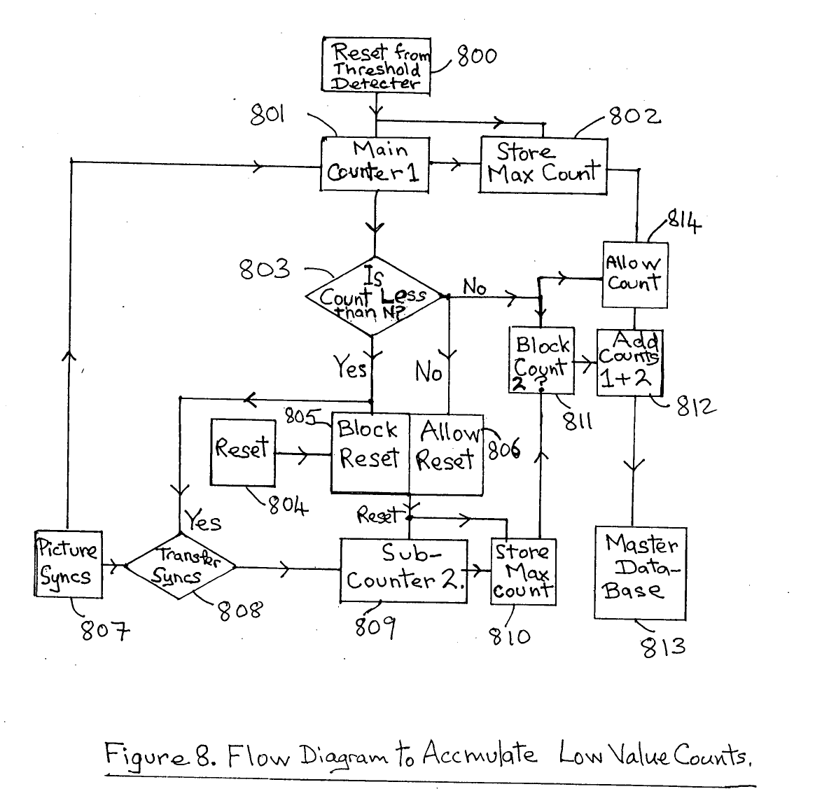

FIG. 8 shows a flow diagram illustrating an exemplary methodology for accumulating low value counts. A reset pulse is received at step 800 from a threshold detector when a shot change occurs that resets the main counter 1 to zero. At step 801, main counter 1 receives synchronizing pulses at picture rate from picture synchronization step 807. Reset pulse from step 800 is also used to enable temporary store, at step 802, to retain the maximum count obtained by the counter just before it is reset. At step 803, system determines whether the value of the count is less than N. If the value of the word count is less than N, picture synchronizations from step 807 are also used to actuate sub-counter 2 at step 809, via a transfer of the syncs using step 808. If the word count is greater than or equal to N, then syncs transfer step 808 blocks the syncs transfer to the sub-counter 2. Further, step 805 blocks a reset from step 804 such that the sub-counter 2 is not reset to zero. Counter 2 will continue to count as long as the main counter never reaches a count of N or more. At step 814, a maximum count from step 802 is blocked from being included to the counter additions at step 812. The purpose of counter additions at step 812 is to add the maximum counts from the main counter 1 to that from the sub-counter 2 when the main counter 1 reaches a count that is equal N or more. When the main counter 1 reaches a value of N or more, the sub counter 2 is reset to zero at step 809 and the maximum count is stored using step 810. The count is allowed to pass block count step 811 to counter additions at step 812, and the main maximum count from step 802 is not blocked by step 814 so that both counts are added at step 812. At step 813, the results from step 812 are stored in a master database. Thus, all pictures are counted by either counter 1 or counter 2 and the accumulated value from 2 is added to the main counter's value when the main counter reaches a value of N or more and delivers that count to the data base when the next shot change occurs.

In systems, in accordance with one or more embodiments of the present invention, incorrect or miss-logged vectors do not defeat the accurate detection of the motional media, because of its ability to ascertain and compare another or more vectors in a sequence and to re-establish an adequately small probability of a false positive identification.

In one or more embodiments of the present invention, chosen number for the exclusion of logged vectors can have any value. In one embodiments of the present invention, chosen number for the exclusion of logged vectors can be at least four. In another embodiments of the present invention, chosen number for the exclusion of logged vectors can be at least eight. One advantage of using higher numbers is that the total values inserted in the database are reduced thus reducing database capacity. A further advantage is that there would be improvements in the robustness of the system. One disadvantage is that the higher numbers could decrease the number of vectors logged for short programs such as thirty second advertisements and many music videos. In both of these types of genre, it is common to have frequent shot changes and fast wipes and other rapid movement in the content so the exact choice of the number must be a carefully weighed decision. The numbers two, three, four, five, six and eight or more are all reasonable values to achieve the required balance and correspond to 12, 8, 6 about 5, 4 and 3 shot changes per second for movies, and 15, 10, about 8, 6, 5 and about 4 shot changes per second for NTSC television respectively.

In practice the number can be varied according to the genre of the content. So for advertisements, music videos and action movies one might chose a number lower in the range, for documentaries and drama or historical plays, one might chose rather higher numbers in the range.

An incidental advantage of the system that logs numbers that are greater than a chosen value, such as three in the above example is that zero, one, two and three are forbidden values for vectors in the database. The value zero cannot occur in any case because obviously it is not possible to have no pictures between a shot-change. There must always be at least one picture count by the main counter to detect a change in scene. Therefore, the value zero is always forbidden in any and all of the systems that are described herein.

This gives a valuable degree of freedom, in that these numbers can be used to signal other kinds of information instead. For example, if certain auxiliary information is to be inserted in the vector sequence that assists in rapid searches of the database, but is not an actual measured vector, then such an insert can be preceded by a forbidden number. When, for example, any amount of information is inserted, then end of that other data stream is indicated by number two. The only rule to be followed is that the inserted data stream must basically obey the forbidden value rule, that is, it should not contain any data that would correspond to values of zero, one, two or three.

However, the rule can be relaxed when value one is used to indicate the start of the auxiliary data stream and the value two is used to indicate the end of that information. In this scenario, values of zero, one and three would be admissible values in that data, and only the value corresponding to two would be a forbidden state. Else, the value corresponding to two would be an erroneous indication of the end of the data stream would be signaled. There are no limits to the amount of data that can be inserted and, therefore, one obtains a very important degree of freedom. In one or more embodiments of the present invention, total data identifying the motional media program must be kept to a small value in order to minimize database capacity. Auxiliary data insertion must, therefore, be chosen carefully, and known methods of compression (e.g., 7-zip) should be considered.

Although the auxiliary data can be of any nature and for any purpose, potentially important types of data would include reference information such as time code, vector hashes or other means to facilitate quick search capabilities, data about the genre, content details or chapter of the associated media, copy right protection data such as rights to copy or license and ownership information. Any or all of these auxiliary data types are useful inserts in the identity vector data stream that are logged in the database, or may be inserted at the beginning or end of the file as headers or footers.

In summary in these inventions methods and systems have been described that increase the robustness and speed of the system for identification of motional media and allow the identification process to be achieved with any desired accuracy.

Any presently available or future developed computer software language and/or hardware components can be employed in such embodiments of the present invention. For example, at least some of the functionality mentioned above could be implemented using Visual Basic, C, C++ or any assembly language appropriate in view of the processor being used. It could also be written in an interpretive environment such as Java and transported to multiple destinations to various users. One or more embodiments of the present invention can be modified to run on any platform, such as Windows®, Apple®, Sun Systems, IBM, or use UNIX, LINUX, and/or with general or dedicated processors such as an ARM or other type of processor.

The many features and advantages of the embodiments of the present invention are apparent from the detail specification, and thus, it is intended by the appended claims to cover all such features and advantages of the invention that fall within the true spirit and scope of the invention. Further, since numerous modifications and variations may readily occur to those skilled in the art, it is not desired to limit the invention to the exact construction and operation illustrated and described, and accordingly, all suitable modifications and equivalents may be resorted to, falling within the scope of the invention.

What I claim is:

1. A method for identifying motional picture media content, comprising:
deriving at least one of a plurality of synchronization pulses at content rate of a first motional picture media;
storing at least one of a plurality of pictures from the first motional picture media content, wherein the storing is actuated by at least one of the plurality of synchronization pulses;
selecting at least one of the plurality of stored pictures;
comparing at least one of the selected picture with at least one of adjacent pictures of the first motional picture media;
removing filter components from at least one of a plurality of signals, the at least one of the plurality of signals is selected from at least one of the compared pictures;
detecting an indicia for at least one change in at least one of a plurality of properties of at least one of the adjacent pictures content;
adjusting a threshold value of at least one of the plurality of adjacent picture content properties based on the detected indicia;
storing at least one of the plurality of adjusted pictures in a database;
deriving at least one of a plurality of first vectors of at least one of the plurality of adjusted pictures from the first motional picture media, wherein the plurality of adjusted pictures is a sequence, and wherein the first vectors of the adjusted pictures are between shot changes;
comparing the at least one of the plurality of first vectors with at least one of a plurality of second vectors of at least one of a plurality of pictures from a second motional picture media;
determining whether the at least one of the plurality of first vectors is substantially similar to the at least one of the plurality of second vectors;
retrieving identity data corresponding to the second motional picture media if the at least one of the plurality of first vectors is substantially similar to the at least one of the plurality of second vectors; and
displaying the retrieved identity data corresponding to the second motional picture media.

2. The method of claim 1, further comprising:
restricting use of second motional picture media if the at least one of the plurality of first vectors is not substantially similar to the at least one of the plurality of second vectors;
retrieving copy control data corresponding to the second motional picture media; and
displaying copy control information corresponding to the copy control data.

3. The method of claim 1, wherein at least two pictures are selected from at least one of the plurality of stored pictures.

4. The method of claim 1, wherein the threshold value prevents false shot change detections, wherein the detected indicia for changes in at least one of the plurality of properties of at least one of the adjacent pictures content is a substantially low value.

5. The method of claim 1, wherein the first and second vectors are counts of the pictures between shot changes.

6. The method of claim 1, wherein the first and second vectors are time codes between shot changes.

7. The method of claim 1, wherein the identity data comprises ownership and copyright information.

8. The method of claim 1, further comprising the step of retrieving ancillary data associated with identity data corresponding to the second motional picture media.

9. The method of claim 8, wherein ancillary data comprises date of production, date of copyright, artists, director, producer and locations used in the work.

10. The method of claim 1, wherein the at least one of the plurality of first and second vectors is assigned zero counts, wherein the zero counts triggers a data reduction.

11. The method of claim 2, wherein the copy control information is at least one of: Copy Never: Pre-Recorded Media, No Home Use, and Copy Never: Trusted Source.

12. The method of claim 1, wherein the plurality of first and second vectors is assigned at least two successive zero counts, wherein the at least two successive zero counts triggers recognition of ancillary data.

13. The method of claim 1, wherein the motional media is at least one of: movies, video games, computer games, television programs, advertisements, graphics and music videos.

14. The method of claim 1, further comprising:
resetting at least one of the plurality of first vectors of at least one of the plurality of adjusted pictures from the first motional picture media;
deriving at least one of the reset first vectors of at least one of the plurality of adjusted pictures from the first motional picture media; and
storing the at least one of the plurality of reset first vectors.

15. The method of claim 1, wherein the at least one of the picture content properties is brightness.

16. The method of claim 1, wherein the indicia for at least one change in at least one of the pictures content properties is low brightness.

17. The method of claim 1, wherein the indicia for at least one change in at least one of the pictures content properties is a flicker.

18. The method of claim 1, wherein the indicia for at least one change in at least one of the pictures content properties is rapid picture movement.

19. The method of claim 1, wherein the filter component is low frequency filter.

20. The method of claim 1, wherein the filter component is multi-dimensional pixels.

21. The method of claim 1, further comprising the step of restoring a DC offset of at least one of the plurality of signals selected from at least one of the compared pictures.

22. The method of claim 1, wherein the signals comprises color signal components and luminance component.

23. The method of claim 1, wherein the signals comprises Chroma signal components and Luma component.

24. A system for identifying motional picture media content, comprising:
a programmable storage media comprising a first motional picture media;
a synchronization device for deriving at least one of a plurality of synchronization pulses at content rate of a first motional picture media;
an actuator for actuating at least one of the plurality of synchronization pulses, wherein the at least one of the plurality of actuated synchronization pulses actuates storing at least one of a plurality of pictures from the first motional picture media content;
a subtractor for comparing at least one of the selected picture with at least one of adjacent pictures of the first motional picture media;
a low-pass filter for removing filter components from at least one of a plurality of signals, the at least one of the plurality of signals is selected from at least one of the compared pictures;
a detector for detecting an indicia for at least one change in at least one of a plurality of properties of at least one of the adjacent pictures content;
a variable gain element for adjusting a threshold value of at least one of the plurality of adjacent picture content properties based on the detected indicia;
a storage device for storing at least one of the plurality of adjusted pictures;
a media player for deriving at least one of a plurality of first vectors of at least one of the plurality of adjusted pictures from the first motional picture media, wherein the plurality of adjusted pictures is a sequence, and wherein the first vectors of the adjusted pictures are between shot changes;
a first processor for comparing the at least one of the plurality of first vectors with at least one of a plurality of second vectors of at least one of a plurality of pictures from a second motional picture media;
a second processor for retrieving identity data corresponding to the second motional picture media, wherein the at least one of the plurality of first vectors is substantially similar to the at least one of the plurality of second vectors; and
a display device associated with the media player for displaying the retrieved identity data corresponding to the second motional picture media.

25. The system according to claim 24, wherein the media player is capable of reading and/or writing at least one of: CD video (CDV), Digital Versatile Disc (DVD), High-Definition DVD (HD-DVD), Blu-ray discs (BD), Digital Video Recorder (DVR), Random Access Memory (RAM), Read-Only Memory (ROM), magnetic storage media, or a flash memory device.

26. The system according to claim 24, wherein the media player analyzes content of the programmable storage media in about real time.

27. The system according to claim 24, wherein the media player is capable of analyzing content of a motional media stored on a remote database accessible via the Internet.

28. A method for identifying motional picture media content, comprising:
deriving at least one of a plurality of synchronization pulses at content rate of a first motional picture media;
selecting at least one of the plurality of stored pictures;
comparing at least two of the selected picture with at least one of adjacent pictures of the first motional picture media;
detecting an indicia for at least one change in at least one of a plurality of properties of at least one of the adjacent pictures content;
adjusting a threshold value of at least one of the plurality of adjacent picture content properties based on the detected indicia;
deriving at least one of a plurality of first vectors of at least one of a plurality of pictures from a first motional picture media, wherein the plurality of pictures comprises a sequence of the first motional picture media, and wherein the first vectors of the pictures are substantially between at least one of shot and/or event changes of the first motional picture media;
resetting at least one of the plurality of first vectors of at least one of the plurality of adjusted pictures from the first motional picture media;
deriving at least one of the reset first vectors of at least one of the plurality of adjusted pictures from the first motional picture media;
storing the at least one of the plurality of reset first vectors;
searching at least one database for a second motional picture media, wherein the second motional picture media is substantially similar to the first motional picture media with reference to said identifying; and
controlling use of the first motional picture media responsive to a comparison of the at least one of the plurality of first vectors to at least one of a plurality of second vectors of at least one of a plurality of pictures from the second motional picture media.

29. The method of claim 28, further comprising:
restricting use of the first motional picture media if the at least one of the plurality of first vectors is not substantially similar to at least one of a plurality of second vectors of at least one of a plurality of pictures from the second motional picture media; and
displaying copy control information corresponding to the second motional picture media to a user for controlling access to the first motional picture media.

30. The method of claim 28, further comprising:
adjusting an average of at least two of the plurality of properties of at least two of the adjacent pictures content to yield a substantially constant value.

31. A method for identifying motional picture media content, comprising:
deriving at least one of a plurality of synchronization pulses at content rate of a motional picture media;
determining at least one change in at least one of a plurality of properties of at least one of a plurality of pictures compared to at least one of adjacent pictures, wherein at least one of the plurality of pictures is selected from the motional picture media;
adjusting at least one of a plurality of properties of at least one of the adjacent pictures content; and
resetting at least one of a plurality of vectors of at least one of the plurality of adjusted pictures from the motional picture media, wherein resetting is actuated by at least one of the plurality of synchronization pulses.

32. The method of claim 31, further comprising:
deriving at least one of the reset vectors of at least one of the plurality of adjusted pictures from the motional picture media; and
controlling use of the motional picture media responsive to a comparison of at least one of the plurality of the reset vectors with at least one of a plurality of original vectors from original motional picture media, wherein the reset and original vectors are substantially between at least one of shot and/or event changes of the motional picture media and the original motional picture media.

33. A method for identifying motional picture media content, comprising:
deriving at least one of a plurality of synchronization pulses at content rate of a varying media;
determining at least one variation in at least one of a plurality of properties of at least one of a plurality of frames compared to at least one of adjacent frames, wherein at least one of the plurality of frames is selected from the varying media; and
resetting at least one of a plurality of vectors of at least one of the plurality of adjusted frames from the varying media, wherein resetting is actuated by at least one of the plurality of synchronization pulses.

34. The method of claim 33, further comprising:
adjusting at least one of a plurality of properties of at least one of the adjacent frames content.
